(19) United States
(12) Patent Application Publication
(10) Pub. No.: US 2026/0368057 A1
(43) Pub. Date: Nov. 19, 2026

(54) MONITORING OF MACHINE SYSTEMS

(71) Applicant: NVIDIA Corporation, Santa Clara, CA (US)

(72) Inventors: Vito Magnanimo, Munchen (DE); Igor Stoppa, Uusimaa (FI); Mohamed Saad Abdelhameed, Dachau (DE); Raghavendra Vishnu Kumar, Bangalore (IN)

(21) Appl. No.: 19/387,068

(22) Filed: Nov. 12, 2025

Related U.S. Application Data
(60) Provisional application No. 63/807,390, filed on May 16, 2025.
(60) Provisional application No. 63/811,315, filed on May 23, 2025.
(60) Provisional application No. 63/816,860, filed on Jun. 3, 2025.

(51) Int. Cl. G06F 11/30

(52) U.S. Cl. CPC G06F 11/3048; G06F 11/3055

(57) ABSTRACT

In various examples, systems and methods may relate to a system monitoring mechanism. The monitoring mechanism may include validating the health statuses of processes based at least on a combined response including a set of individual responses corresponding to a set of individual processes. The combined response may be compared to an expected response to determine the health statuses of the processes. In some embodiments, the combined response and the expected response may be defined based at least on a challenge number and a set of functions defined to modify the challenge number.

### CROSS-REFERENCE TO RELATED APPLICATIONS

This application claims the benefit of U.S. Provisional Application No. 63/807,390 filed on May 16, 2025, U.S. Provisional Application No. 63/811,315 filed on May 23, 2025, and U.S. Provisional Application No. 63/816,860 filed on Jun. 3, 2025, the contents of which are hereby incorporated by reference in their entireties.

### BACKGROUND

A watchdog is a supervisory mechanism—typically implemented as a hardware timer or software monitor—used to detect and recover from system malfunctions, particularly in embedded or real-time systems. The watchdog is configured to identify the system becoming unresponsive or entering an unexpected execution path. In such instances, the watchdog resets the system and/or triggers a predefined safe state to keep the system operational. The watchdog expects periodic kicks or pings from the system or a specific software component. In instances the watchdog does not receive a ping in time, the watchdog assumes the system is hung or malfunctioning and takes appropriate actions, such as restarting the system.

The watchdog is effective at detecting that a system has become unresponsive or has entered an invalid state. The watchdog is designed such that the watchdog only monitors whether the system kicks or refreshes the watchdog within a given time window such that that while the watchdog may help ensure system availability typical watchdogs lack insights into the root cause of failures.

### SUMMARY

Embodiments of the present disclosure relate to multi-level watchdog timer. Systems and methods are disclosed that improve the watchdog mechanisms for a monolithic system. In particular, the embodiments of the present disclosure may help implement a multi-level watchdog mechanism configured to monitor and detect system malfunctions at various levels. For example, the multi-level watchdog may include monitoring mechanisms at the kernel level, the process level, and the thread level, such that the source of system malfunctions may be identified. Different parts may send signals up to a higher level which may be combined and/or verified at the watchdog level.

In some embodiments, the watchdog may be configured to receive a combined response corresponding to a challenge number. The combined response may include a set of responses respectively corresponding to a set of processes. In some embodiments, individual responses of the set of responses may be based at least on reception of heartbeat signals corresponding to individual processes of the set of processes. The individual responses may represent the statuses of the individual processes and/or one or more child processes associated with the individual processes. In these and other embodiments, one or more health statuses respectively corresponding to one or more of the individual processes of the set of processes may be determined based at least on a comparison between the combined response and the challenge number. The comparison may identify a mismatch with respect to a part of the combined response associated with an individual process. Such mismatch may indicate an issue or an unhealthy status of the individual process and/or associated child processes.

In contrast to conventional systems which do not provide context about which function, thread, or component caused the failure, the systems and methods of the present disclosure may provide insights into the source of the system malfunctions or issues that are causing verification failures by the watchdog mechanism. Such insights may help resolve the system malfunctions with improved granularity.

### BRIEF DESCRIPTION OF THE DRAWINGS

The present systems and methods for multi-level watchdog are described in detail below with reference to the attached drawing figures, wherein:

FIG. 1A is an example of a multi-level watchdog configured to monitor various processes of a system, in accordance with at least some embodiments of the present disclosure;

FIG. 1B is an example of a first level watchdog of the multi-level watchdog, in accordance with at least some embodiments of the present disclosure;

FIG. 1C is an example of a second level watchdog of the multi-level watchdog, in accordance with at least some embodiments of the present disclosure;

FIG. 1D is an example of a third level watchdog of the multi-level watchdog, in accordance with at least some embodiments of the present disclosure;

FIG. 1E is an example of a fourth level watchdog of the multi-level watchdog, in accordance with at least some embodiments of the present disclosure;

FIG. 2 is a flow diagram showing a method for monitoring of machines systems, in accordance with some embodiments of the present disclosure

FIG. 3A is an example of sensor locations having corresponding fields of view or sensory fields for example autonomous or semi-autonomous machines, in accordance with at least some embodiments of the present disclosure;

FIG. 3B is an illustration of an example of component and sensor locations on an autonomous or semi-autonomous vehicle, in accordance with at least some embodiments of the present disclosure;

FIG. 3C is a block diagram of an example system architecture for an autonomous or semi-autonomous vehicle, robot, and/or other machine type, in accordance with at least some embodiments of the present disclosure;

FIG. 3D is a block diagram of an example architecture of a computing system such as a system-on-a-chip (SoC)—in accordance with at least some embodiments of the present disclosure;

FIG. 3E is a system diagram for communication between cloud-based server(s) and an example autonomous or semi-autonomous vehicle, robot, and/or other machine type, in accordance with at least some embodiments of the present disclosure;

FIG. 4 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 5 is a block diagram of an example computing system for generative artificial intelligence (AI), in accordance with at least some embodiments of the present disclosure; and

FIG. 6 is a block diagram of an example computing device, in accordance with at least some embodiments of the present disclosure.

### DETAILED DESCRIPTION

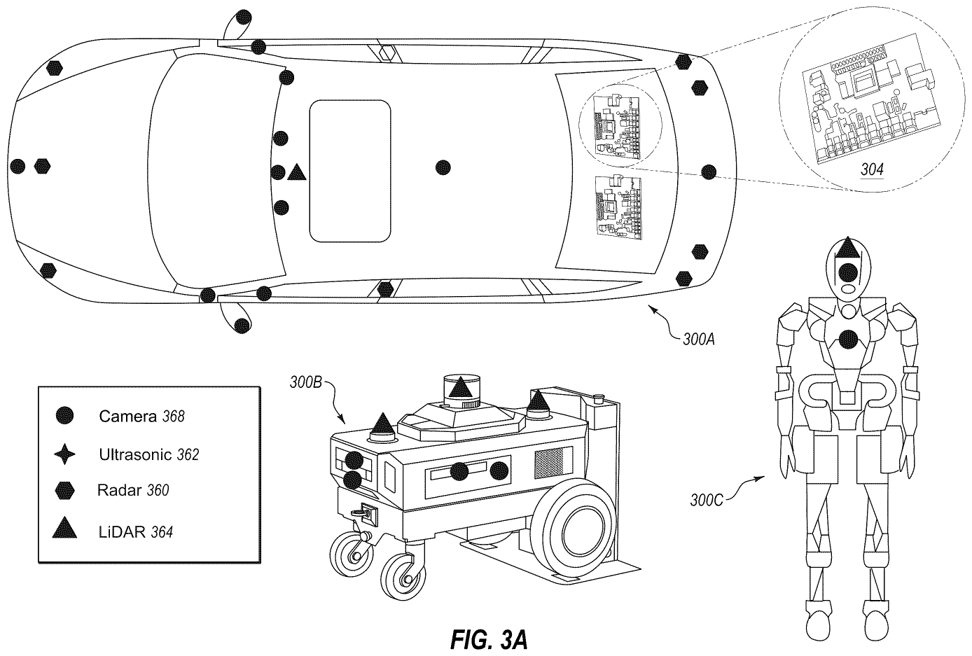

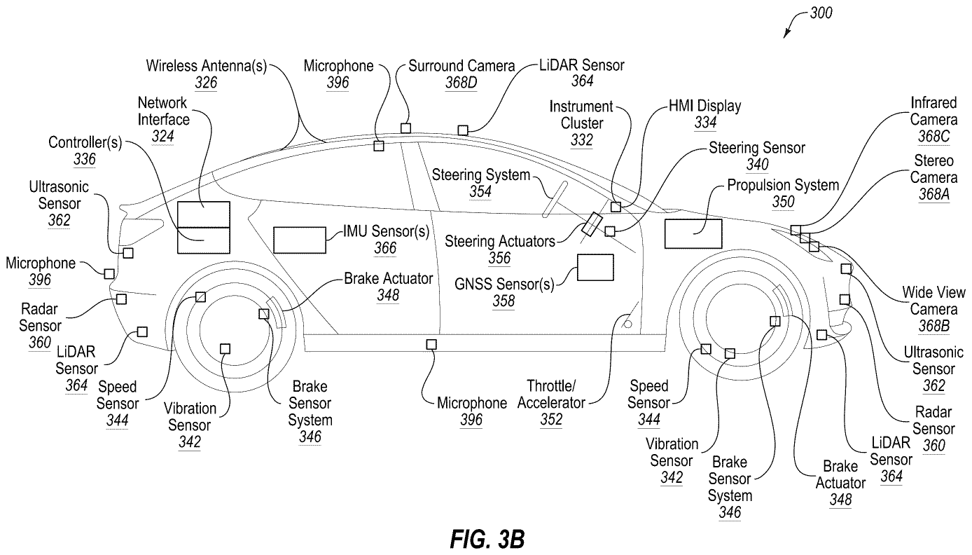

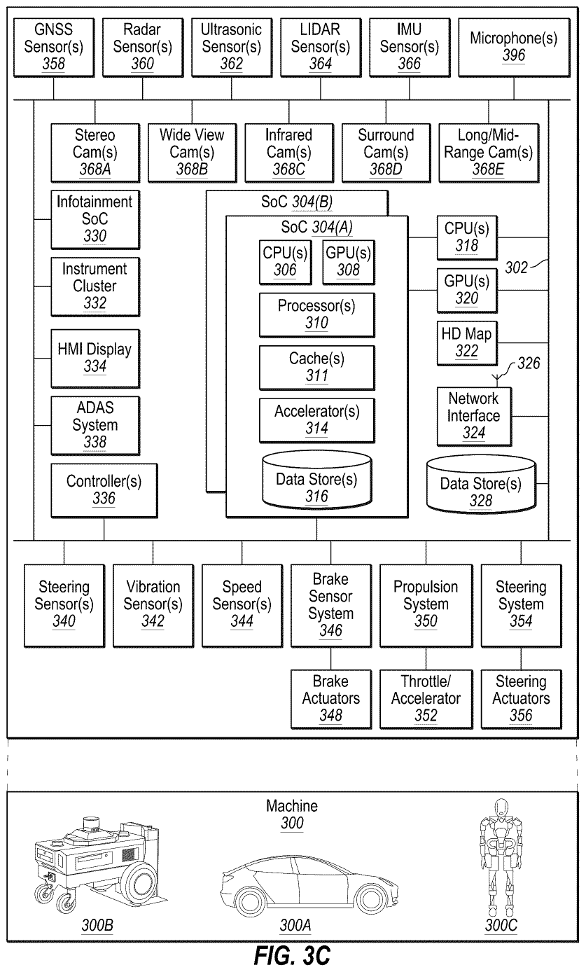

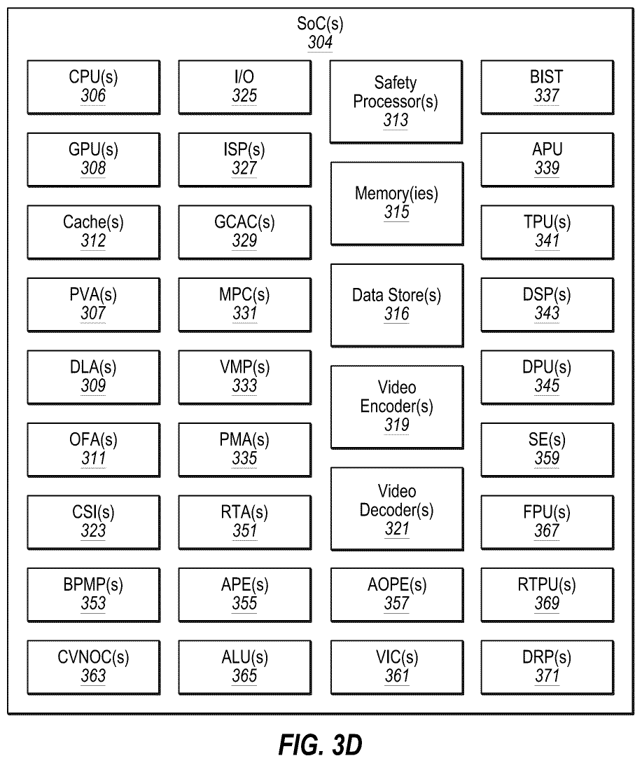

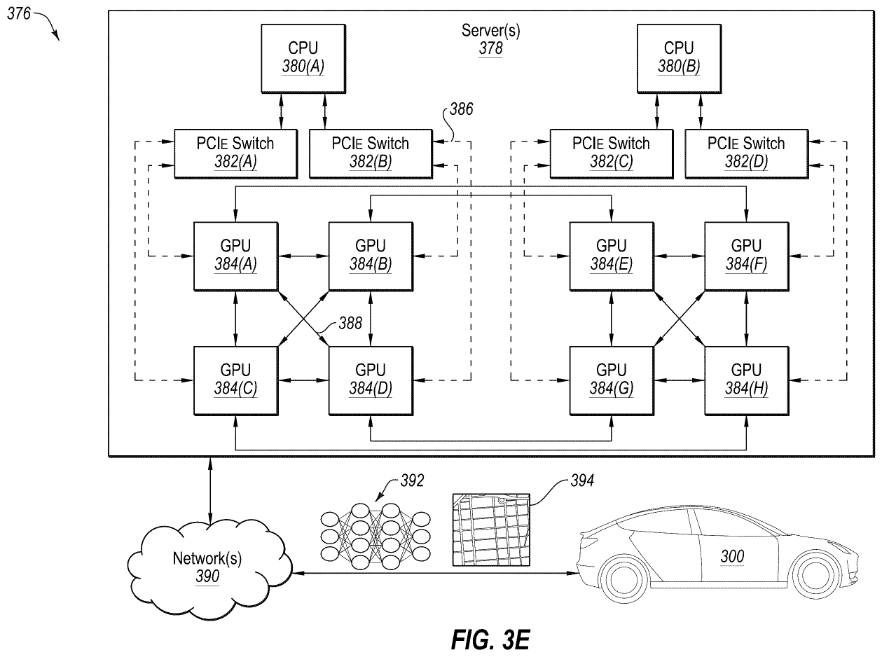

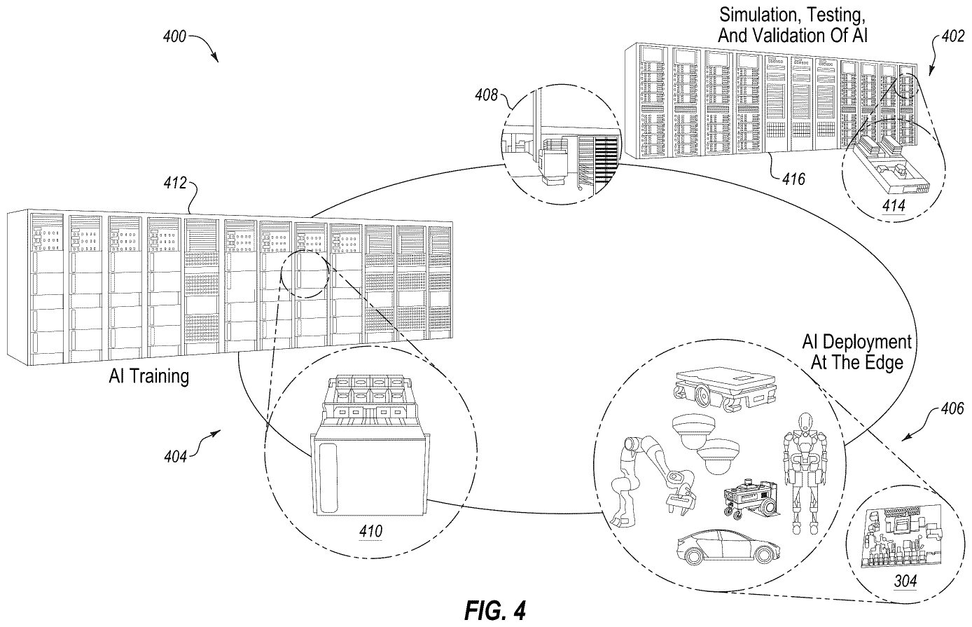

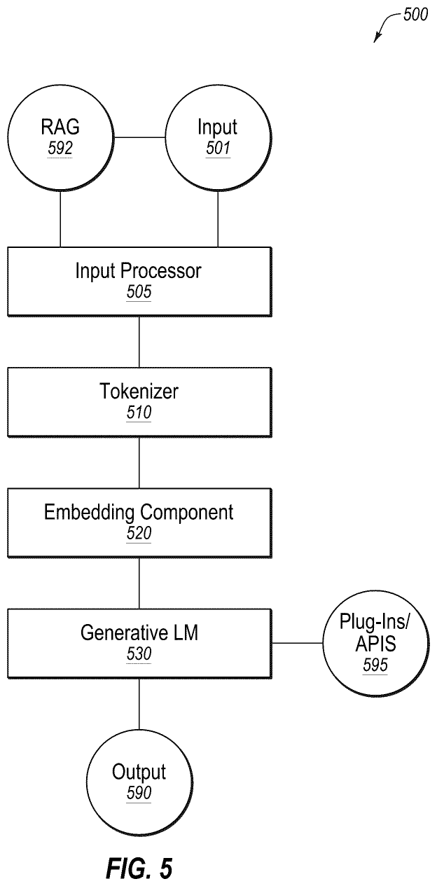

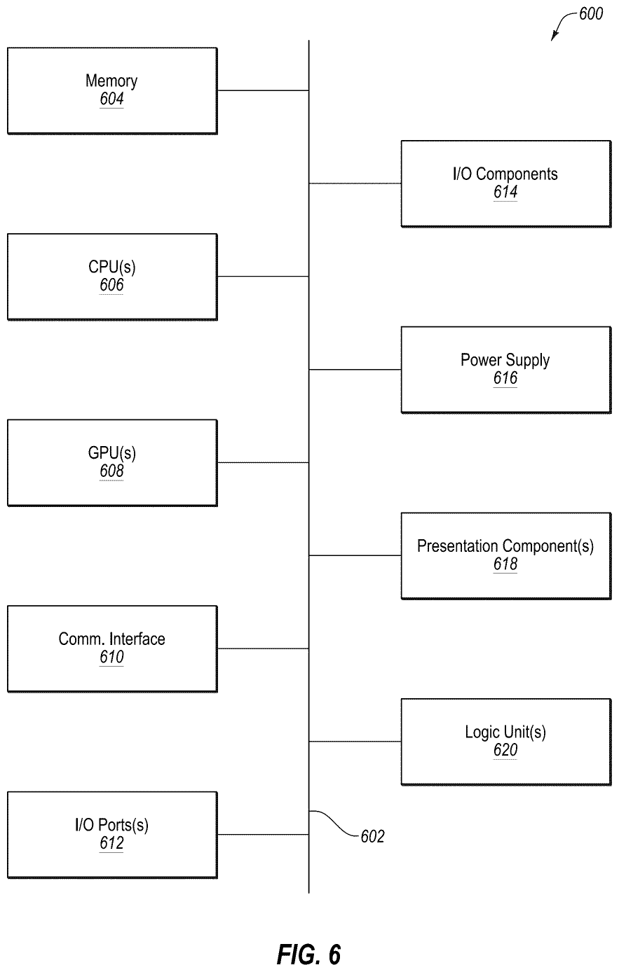

Systems and methods are disclosed related to a multi-level watchdog mechanism. Although the present disclosure may be described with respect to an example autonomous or semi-autonomous vehicle, robot, and/or other machine type 300 (alternatively referred to herein as “vehicle 300,” “ego-vehicle 300,” “machine 300,” “ego-machine 300,” “robot 300,” and/or “ego-robot 300,” an example of which is described with respect to FIGS. 3A-3E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to a system monitoring mechanism for a monolithic system this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where system monitoring may be used. In some embodiments, the systems, methods, and/or processes described herein may be executed using similar components, features, and/or functionality to those of example machine 300 of FIGS. 3A-3E, example computing ecosystem 400 of FIG. 4, example generative language model system 500 of FIG. 5, and/or example computing device 600 of FIG. 6.

One or more embodiments of the present disclosure may relate to a system monitoring mechanism. In particular, the embodiments of the present disclosure may relate to a multi-level watchdog system. The multi-level watchdog system may be a hierarchical fault detection mechanism or system including multiple levels or layers ranging from low-level threads to the kernel. Each level may be configured to receive data from the level directly below to generate cumulative responses that may be compared to the expected response at the highest level.

In some embodiments, the watchdog system may be configured such that the watchdog is successfully pinged or kicked in response to receiving a response that matches the expected response. For example, instead of resetting the timer in response to receiving a kick or a response, the watchdog may verify the content of the received response to verify that the received response matches the expected response. In these and other embodiments, a mismatch may indicate an issue. In some embodiments, the response may be a combined response including a set of responses respectively corresponding to a set of processes. The processes may refer to the init or root processes associated with a group of processes.

In some embodiments, the expected response may be a number including a certain number of bits. For example, at the first or the highest level, the watchdog system may include a random number generator configured to randomly generate a number including 64 bits (e.g., bits 0-63). While illustrated with 64 bits, the random number generator may include any suitable number of bits. In these and other embodiments, the raw 64-bit number may be considered as a challenge number or the number that is provided to lower levels. In some embodiments, the watchdog may process the challenge number to generate a number corresponding to the expected response. The challenge number may also be provided to lower levels of the multi-level watchdog architecture. The lower levels may determine a response based at least on the challenge number. The lower levels may communicate the response to the watchdog in response to successfully verifying that different functions being monitored by the watchdog are operating as expected.

In these and other embodiments, the source of the issue may be identified with respect to different categories of functionalities. For example, the functionalities of a system may be categorized and grouped into multiple groups based at least on the categories. The watchdog may be configured such that the watchdog sends a challenge to be solved at lower layers (e.g., the kernel layer, process layer, thread layer, etc.). The challenge may be divided into multiple divided challenges corresponding to the groups of functionalities. Each divided challenge may be solved with respect to the corresponding group of functionalities. In these and other embodiments, the response generated based on the solving of the multiple divided challenges may indicate which, if any, group(s) of categories are having issues.

One or more embodiments of the present disclosure may help improve the level of insights provided by a watchdog. For example, some existing watchdog timers are periodically reset in response to a kicking or refreshing of the watchdog by the system. In instances the watchdog timer is not refreshed within a predefined time window, an assumption is made that the system is unresponsive or has failed. In such instances, a recovery action, such as rebooting the machine or restarting a process, may be taken.

However, such existing watchdogs are limited in scope. Typical watchdogs only monitor whether the watchdog is kicked or pinged on time, without providing context about the state of the system at the moment of failure. For example, typical watchdogs do not capture which function, thread, or component caused the hang or crash. For example, existing watchdogs generally lack mechanisms to track or log detailed runtime information such as the system state, stack traces, or execution flow when the failure occurs. Accordingly, existing watchdogs are effective in automatically recovering from failures and keeping a system available, however, the watchdogs fail to provide the diagnostic details for determining the root cause of the problem.

In some embodiments, the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to determine safe detection of failures, etc., and this information may be used to perform operations associated with the virtual machine within the simulation environment. These simulated operations may be used to test performance of the underlying algorithms, systems, and/or processes prior to deploying them in the real-world. In some instances, the simulation may be used to generate synthetic training data—e.g., detection of failures from within the simulation.

In any example, such as where a simulation environment is used for testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

In some embodiments, the system and methods described herein may be deployed in a robotics application. For example, a robot or robotic system may include one or more onboard processors (e.g., CPUs, GPUs, hardware-based deep learning accelerators (DLAs), deep learning accelerator clusters (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models, vision language models (VLMs), large language models (LLMs), vision-language-action (VLA) models, multi-modal language models (MMLMs), etc.) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, VLAs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), deep learning accelerator cluster (XNNs), neural processing units (NPUs), neural network accelerators (NNAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

In some examples, the machine learning model(s) (e.g., deep neural networks, language models, LLMs, VLMs, multi-modal language models, vision-language-action (VLA) models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), vision-language-action (VLA) models, etc.), and/or other types of machine learning models.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

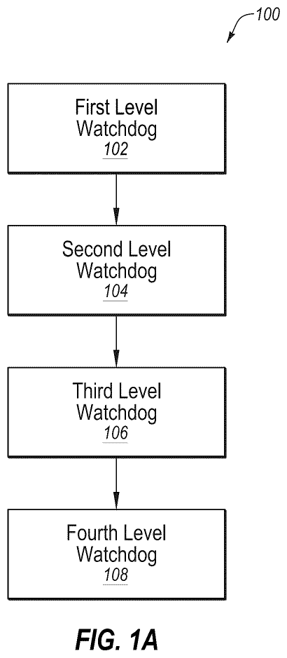

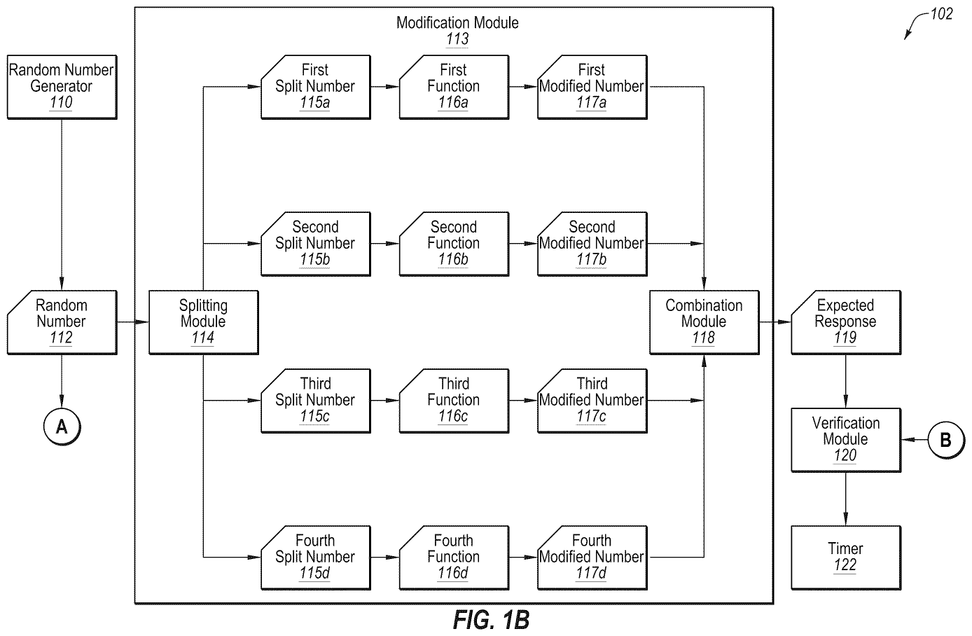

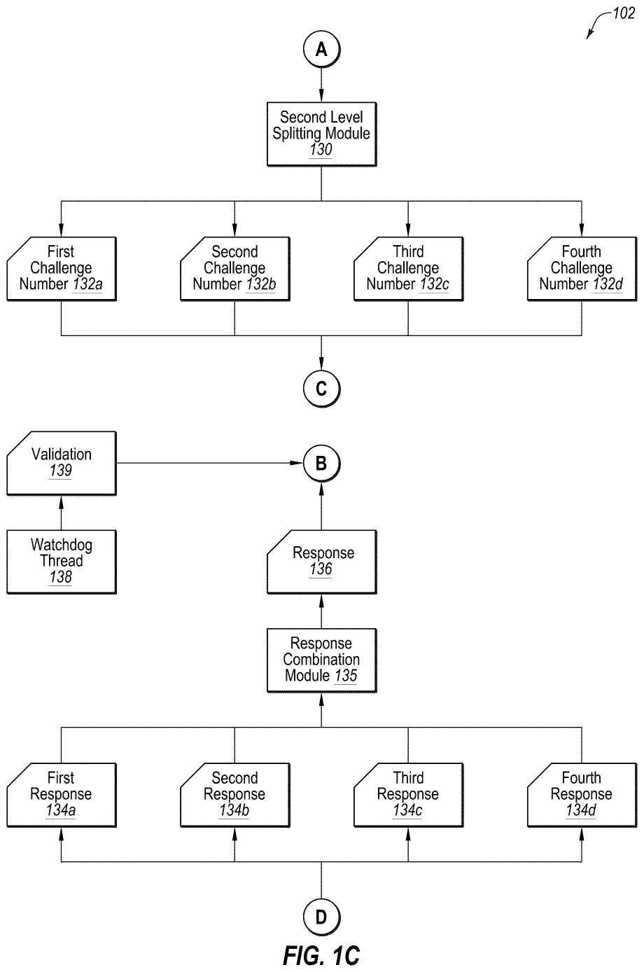

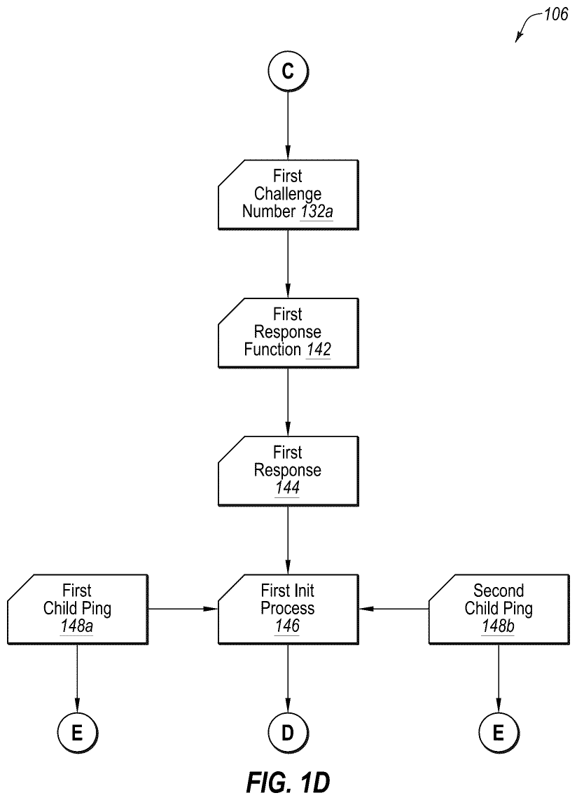

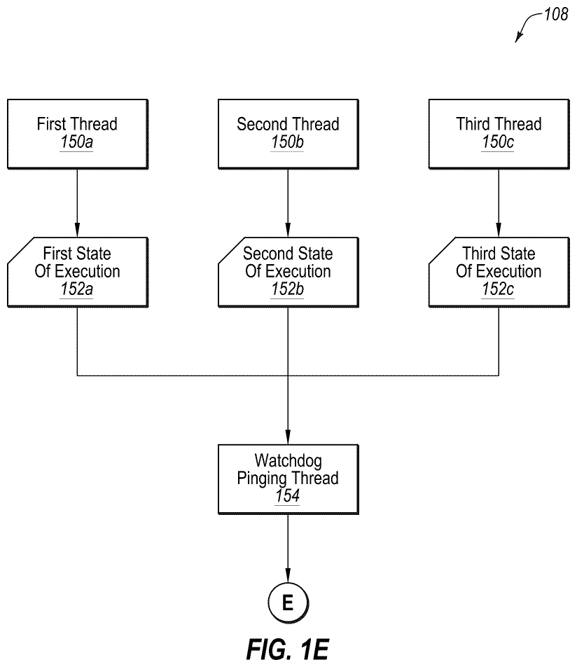

With reference to FIG. 1, FIG. 1A illustrates an example multi-level watchdog 100 configured to monitor various processes of a system, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 300 of FIGS. 3A-3E, example computing ecosystem 400 of FIG. 4, example generative language model system 500 of FIG. 5, and/or example computing device 600 of FIG. 6.

In general, the multi-level watchdog 100 may include a first level watchdog 102, a second level watchdog 104, a third level watchdog 106, and a fourth level watchdog 108. In some embodiments, the multi-level watchdog 100 may be defined as a hierarchical monitoring framework configured to provide fault detection and recovery across different layers of a monolithic system. Different levels of the multi-level watchdog 100 may be configured to target a specific scope of execution. In the present disclosure, a reference to a watchdog may include a reference to a mechanism configured to monitor certain parts of the monolithic system. For example, the second level watchdog may refer to the kernel of the system configured to monitor certain parts of the system.

The first level watchdog 102 may be a hardware or base system watchdog configured to monitor the operating system as a whole. The first level watchdog may be configured as the main watchdog element configured to monitor and verify that the system is working as expected. In general, the first level watchdog may include a timer configured to be periodically reset. For example, the timer may begin counting down as the first level watchdog is started. In response to determining that the system is operating as expected, the timer may be refreshed or reset to the initial value. The timer expiring without receiving a refresh signal may indicate a presence of an issue or a failure. In response to the timer expiring, the first level watchdog may be configured to take a corrective action, such as resetting the system restarting a process, and/or raising an error signal.

In some embodiments, the first level watchdog 102 may be configured to receive a combined response from the lower-level watchdogs. The combined response may include a set of individual responses corresponding to individual processes. The first level watchdog 102 may determine the health statuses of the individual processes based at least on the combined response. For example, the first level watchdog 102 may compare the combined response to an expected response. In these and other embodiments, the combined response and the expected response may be both generated based at least on a challenge number based at least on the same set of functions, such that a mismatch between the expected response and the combined response may indicate an issue with at least one process of the system. In these and other embodiments, the lower-level watchdogs (e.g., the second level watchdog 104, the third level watchdog 106, and/or the fourth level watchdog 108) may be configured to monitor the health and/or operations of the processes and/or the system at different hierarchical levels to define and communicate the combined response to the first level watchdog 102.

For example, the second level watchdog 104 may be configured to monitor certain kernel features such as interrupt request (IRQ) timeouts. Additionally or alternatively, the second level watchdog 104 may be configured to verify that the processes are operating as expected and notify the results to the first level watchdog 102. In some embodiments, the second level watchdog 104 may verify the statuses of the processes based at least on the communication with the third level watchdog 106. In the present disclosure, a reference to the second level watchdog 104 may include a reference to the kernel implementing the second level watchdog 104.

The third level watchdog 106 may refer to the systems configured to monitor and verify the statuses and/or health of the processes. In particular, the third level watchdog 106 may include parent initialization (init) processes associated with a group of processes. For example, the functionalities of a monolithic system may be categorized based at least on a standard. In some embodiments, the standard may be safety related. For example, the functions may be categorized based at least on different safety standards that are applicable to different fields or industries. For example, the functions may be categorized based at least on standard such as ISO 26262 (for automotive), DO-178C (for aerospace), IEC 61508 (for industrial automation), IEC 62304 (for medical device), among others. In general, such standards may define different safety requirements applicable to different functions.

As an example, with respect to an automotive system and an applicable safety standard of ISO 26262, the functionalities may be categorized based at least on the ASIL levels such as ASIL A, ASIL B, ASIL C, or ASIL D. In some embodiments, the functionalities may be grouped together based at least on the categories. For example, a first group of functionalities may include functionalities associated with ASIL A, a second group of functionalities may include functionalities associated with ASIL B, a third group of functionalities may include functionalities associated with ASIL C, and a fourth group of functionalities may include functionalities associated with ASIL D.

In these and other embodiments, each init process may be associated with a group of functionalities and processes associated with an ASIL level. Each init process may be configured to supervise a set of child processes that operate at the same ASIL level. Each child process is configured to periodically report or ping the parent init process within a predetermined temporal window to indicate the operational status. The parent inti process verifies that each child process has successfully reported within the expected timeframe and records the corresponding status information. In response to successfully verifying the child processes, the init processes may report as such to the kernel or the second level watchdog 104.

The fourth level watchdog 108 may be associated with the threads of the processes. For example, threads represent independent units of execution that share the resources of a process. Each thread within the process may have own program counter, stack, and set of registers, such that the thread may execute instruction independently of other threads. Multiple threads of a process may perform concurrent tasks, such as handling input/output operations, background computations, and/or user interactions without the overhead of spawning new processes. Each child process may signal the parent init process in response to verifying that all threads associated with the child process are operating as expected. The structures and data flow between the multi-level watchdogs may be described in further detail with respect to FIGS. 1B-1E of the present disclosure.

For example, FIG. 1B illustrates an example embodiment of the first level watchdog 102, in accordance with one or more embodiments of the present disclosure. In some embodiments, the first level watchdog 102 may include a random number generator 110, a modification module 113, a verification module 120, and a timer 122. In some embodiments, the random number generator 110 may be configured to randomly generate a random number 112. In some embodiments, the random number 112 may have a certain length. For example, the random number 112 may be a N-bit number.

As an example, the random number 112 may include 64 bits (e.g., bits 0-63). While illustrated with 64 bits, the random number 112 may include any suitable number of bits. In these and other embodiments, the raw 64-bit number may be considered as a challenge number or the number that is provided to lower levels. In some embodiments, the random number 112 may be communicated to the second level watchdog 104 as the challenge number.

As discussed in further detail in the present disclosure, the second level watchdog 104 may be configured to generate a response based at least on the random number 112 and the responses for lower-level watchdogs. The response may be propagated to the first level watchdog 102. The first level watchdog 102 may verify the response from the second level watchdog 104 to determine to reset reload or expire the timer 122. The second level watchdog may be discussed in further detail with respect to FIG. 1C of present disclosure.

In some embodiments, the modification module 113 may be configured to modify the random number 112 to generate an expected response 119. In some embodiments, the modification module 113 may include a splitting module 114 configured to split the random number 112 into a set of split numbers corresponding to the groups of functionalities. For example, in instances the functionalities are categorized into four groups (e.g., ASIL A, ASIL B, ASIL C, and ASIL D), the splitting module 114 may split the random number 112 into a first split number 115a, a second split number 115b, a third split number 115c, and a fourth split number 115d (collectively referred to as split numbers 115) In these and other embodiments, the split numbers 115 may have the same length. For example, in instances the random number 112 is a 64-bit number, the splitting module 114 may generate four 16-bit split numbers. In some embodiments, the 64-bit number may be split such that each split number includes a continuous range of bits. For example, the first split number 115a may include bits 0-15, the second split number may include bits 16-31, the third split number 115c may include bits 32-47, and the fourth split number 115d may include bits 48-63. In other embodiments, the split may be done such that each split number includes random sets of bits.

In some embodiments, the modification module 113 may include one or more functions configured to modify the split numbers 115. For example, the modification module 113 may include a number of functions corresponding to the number of the split numbers 115. For example, the modification module 113 may include a first function 116a corresponding to the first split number 115a, s second function 116b corresponding to the second split number 115b, a third function 116c corresponding to the third split number 115c, and a fourth function 116d corresponding to the fourth split number 115d.

In these and other embodiments, the first function 116a, the second function 116b, the third function 116c, and the fourth function 116d may respectively generate a first modified number 117a, a second modified number 117b, a third modified number 117c, and a fourth modified number 117d, based at least on the first split number 115a, the second split number 115b, the third split number 115c, and the fourth split number 115d, respectively. The first function 116a, the second function 116b, the third function 116c, and the fourth function 116d may be collectively referred to as the functions 116. The functions 116 are configured such that the functions transform a number into another number while maintaining the size of the number. For example, the functions may transform the 16-bit numbers into transformed 16-bit numbers. In some embodiments, the functions 116 may include a deterministic transformation. The transformation may include one or more of a bitwise operation (e.g., exclusive OR), a shift or rotation operation (e.g., rotate left, rotate right), an arithmetic operation (e.g., modular addition, subtraction, multiplication with a constant, etc.), and/or a polynomial or checksum operation (e.g., cyclic redundance check or linear feedback shift register updated).

In some embodiments, the modification module 113 may include a combination module 118 configured to combine the first modified number 117a, the second modified number 117b, the third modified number 117c, and the fourth modified number 117d (collectively referred to as the modified numbers 117) to generate the expected response 119. In some embodiments, the combination module 118 may concatenate the modified numbers 117 to generate the expected response 119.

Now referring to FIG. 1C, FIG. 1C illustrates an example embodiment of the second level watchdog 104, in accordance with one or more embodiments of the present disclosure. In general, the second level watchdog 104 may be associated with the kernel of the monolithic system. The kernel may operate as an intermediary and coordinator between the first level watchdog 102 and the system processes. For example, the kernel may be configured to deliver the challenge number (e.g., the random number 112) to the processes, such that the processes may solve the challenge number to generate a response.

For example, the second level watchdog 104 may include a second level splitting module 130 configured to split the random number 112 received from the first level watchdog 102 to a set of challenge numbers. In some embodiments, the number of challenge numbers may correspond to the number of the split numbers 115. For example, in instances the splitting module 114 of the first level watchdog 102 divides the random number 112 into four split numbers 115, the second level splitting module 130 may divide the random number 112 into four challenge numbers, including a first challenge number 132a, a second challenge number 132b, a third challenge number 132c, and a fourth challenge number 132d (collectively referred to as the challenge number 132). In some embodiments, the challenge numbers 132 may correspond to the split numbers 115. For example, the splitting module 114 and the second level splitting module 130 may split the random number 112 in the same manner such that the split numbers 115 correspond to respective challenge numbers 132. For example, the first split number 115a may be the same as the first challenge number 132a, the second split number 115b may be the same as the second challenge number 132b, the third split number 115c may be the same as the third challenge number 132c, and the fourth split number 115d may be the same as the fourth challenge number 132d. In these and other embodiments, the kernel may communicate the challenge numbers 132 to the third level watchdog 106.

With reference to the third level watchdog 106, FIG. 1D illustrates an example embodiment of the third level watchdog 106, in accordance with one or more embodiments of the present disclosure. FIG. 1D may be illustrated with respect to a part of the third level watchdog 106 associated with a first group of processes. For example, FIG. 1D may illustrate a part of the third level watchdog 106 configured to receive the first challenge number 132a to generate a corresponding response. For example, the third level watchdog 106 may include a first init process 146 configured to monitor the child processes associated with the first init process 146 are operating as expected. The first init process 146 may solve or modify the first challenge number 132a based at least on the first response function 142 to generate the first response 144. The first init process 146 may be configured to communicate the first response 144 to the kernel only in response to verifying that all child processes are operating as expected. For example, in response to not receiving a ping or a signal from one or more child processes, the first init process 146 may withhold the first response 144 from being communicated to the kernel. In response to not receiving the first response 144 from the first init process 146 within a certain timeframe, the kernel may determine a presence of an issue within the first init process 146 and/or at least one child process associated with the first init process 146. In some embodiments, in response to not receiving a ping from one or more child processes, the first init process 146 may further modify the first response 144 to be incorrect or different with respect to the first response function 142. In such instances, the first response 144 may be communicated to the kernel, and the incorrect response may indicate presence of an issue with respect to the first init process 146 and/or the child processes.

In these and other embodiments, the structures and/or the operations described with respect to FIG. 1D may be replicated for each group of processes or the corresponding challenge numbers (e.g., the second challenge number 132b, the third challenge number 132c, and the fourth challenge number 132d). For example, while not illustrated, the third level watchdog 106 may include a second init process, a third init process, and a fourth init process configured to monitor respective child processes. Additionally, the second init process, the third init process, and the fourth init process may be configured to solve the second challenge number 132b, the third challenge number 132c, and the fourth challenge number 132d, respectively.

In some embodiments, the third level watchdog 106 may obtain the first challenge number 132a using a syscall function. For example, the kernel at the second level watchdog 104 may notify the first init process 146 that the data (e.g., the first challenge number 132a) is ready to be read. In some embodiments, the signaling may happen as general or quality management (QM) level, such that an error may prevent the continuation of the watchdog process and cause the watchdog timer (e.g., the timer 122) to expire. The first init process 146 may perform a syscall function in response to the signaling to obtain the respective part of the challenge numbers 132 (e.g., the first challenge number 132a).

In some embodiments, the third level watchdog 106 may include a first response function 142 configured to process the first challenge number 132a. In some embodiments, the first response function 142 may correspond to the first function 116a of FIG. 1B, such that the third level watchdog 106 may modify the first challenge number 132a to a number that corresponds to the first modified number 117a. For example, the first response 144 may correspond to the first modified number 117a. In these and other embodiments, the first response 144 may be propagated to the second level watchdog 104 and the subsequentially to the first level watchdog 102. The first response 144 may be compared to the first modified number 117a to determine that the third level watchdog 106 and/or the first init process 146 has knowledge of the first function 116a (e.g., the first response function 142). The match between the first response 144 and the first modified number 117a may indicate that the first challenge number 132a was properly solved and that the processes associated with the first init process 146 are operating as expected.

In these and other embodiments, the first response function 142 may be independent from the functions defined to transform the second challenge number 132b, the third challenge number 132c, or the fourth challenge number 132d. Such separation may permit separate and more granular monitoring of the processes based on the categories (e.g., ASIL levels) of functionalities.

The first response 144 may be provided to the first init process 146. The first init process 146 may be the first or the root process launched by the kernel following the completion of kernel initialization. The first init process 146 may perform roles such as bootstrapping user space, configuring the runtime environment, spawning login services, among others. In some embodiments, the first init process 146 may be a root process for a group of processes associated with a group of functionalities. For example, the first init process 146 may be a root process for the processes associated with ASIL A functionalities. For example, while not explicitly illustrated, a second init process may be a root process for ASIL B functionalities, a third init process may be a root process for ASIL C functionalities, and a fourth init process may be root process for ASIL D functionalities.

The first init process 146 may be the parent process to multiple processes in the group. For example, multiple child or subsequent processes may be spawned from the first init process 146. In these and other embodiments, the child processes may be configured to ping or send a signal to the first init process 146 in response to a proper or expected initialization and/or operation. The first init process 146 may verify that all child processes in the group (e.g., ASIL A child processes) have pinged the first init process 146. In these and other embodiments, the first init process 146 may be configured to propagate the first response 144 to the second level watchdog 104 only in response to verifying that all child processes have pinged the first init process 146 correctly or as expected. For example, the first init process 146 may be associated with a first child process and a second child process. In response to receiving a first child ping 148a from the first child process and a second child ping 148b from the second child process, the first init process 146 may propagate the first response 144. Contrastingly, in response to the first init process 146 not receiving the first child ping 148a and/or the second child ping 148b, the first init process 146 may withhold the first response 144 from being propagated to the second level watchdog 104.

In some embodiments, the child processes (e.g., the first child process generating the first child ping 148a and the second child process generating the second child ping 148b) may be configured to periodically report the status as alive and operational to a corresponding root init process (e.g., the first init process 146). The reporting period may be determined based at least on physical system parameters, such as vehicle speed relative a distance permitted to be traveled prior to a fault condition is to be detected. In some instances, the init processes and the child processes may communicate in a one-reader-to-many-writers manner, in which a single entity (e.g., the init process) is responsible for consuming or processing incoming messages, and multiple entities (e.g., the child processes) are responsible for producing and sending messages into same communication channel. In such instances, a contention may occur as multiple processes attempt to write respective pings simultaneously. In such instances, some processes may occasionally be blocked from sending the pings to facilitate the one-reader-to-many-writers communication. Such blocking may introduce overhead, but the overhead may be considered an inherent part of the system design, and the system architecture may be configured to tolerate and accommodate such delays.

In some embodiments, the first child process may send the first child ping 148a in response to verifying that all threads of the first child process are operating properly. For example, with reference to FIG. 1E, FIG. 1E illustrates an example embodiment of the fourth level watchdog 108. In some embodiments, the fourth level watchdog 108 illustrated in FIG. 1E may represent how a child process may generate a ping for the init process. While illustrated with respect to a first child process, the structures and operations discussed with respect to FIG. 1E may be applicable to any other child processes sending a ping to an init process.

In some embodiments, the first child process may include or be associated with multiple threads. Threads represent independent units of execution that share the resources of a process. Each thread within the process may have own program counter, stack, and set of registers, such that the thread may execute instruction independently of other threads. Multiple threads of a process may perform concurrent tasks, such as handling input/output operations, background computations, and/or user interactions without the overhead of spawning new processes. As an example, the first child process may include a first thread 150a, a second thread 150b, and a third thread 150c (collectively referred to as the threads 150).

In some embodiments, the first child process may be configured to invoke a self-monitoring health function defined to return an indication of whether the scope of execution of the threads associated with the first child process is currently safe from the perspective of the threads 150. In some embodiments, the threads 150 may be configured to invoke the self-monitoring health function (as invoked by the first child process) based at least on a predefined frequency. In these and other embodiments, each thread may generate a state of execution representing the scope of execution of the thread. For example, the first thread 150a may generate a first state of execution 152a, the second thread 150b may generate a second state of execution 152b, and the third thread 150c may generate a third state of execution 152c.

In some embodiments, the information corresponding to each thread may be stored in a stable table, in which the table includes one or more entries representing one or more of the health statuses reported by the thread, the expected updated frequency of the health status of the thread, and/or the time of the last update relative to the expected temporal window. For example, the first state of execution 152a, the second state of execution 152b, and the third state of execution 152c may be formatted as separate stable tables.

In some embodiments, the fourth level watchdog 108 may include a watchdog pining thread 154 configured to scan the tables to ascertain the status of the first child process as a whole based at least on the information in the tables. The scanning of the tables may permit detection of failure conditions with respect to the threads. Some examples of the failure conditions may include a thread-identified error (e.g., thread internal problem), a failure to execute the thread, among others. The watchdog pining thread 154 may be configured to report the aggregated status of the threads 150 to the first init process 146. For example, the first child ping 148a may correspond to the aggregated status of the threads 150. The first init process 146 may propagate the first response to the second level watchdog 104 in response to receiving pings from all child processes associated with the first init process 146.

Referring back to FIG. 1C, the second level watchdog 104 may receive a first response 134a, a second response 134b, a third response 134c, and a fourth response 134d (collectively referred to as the response 134) from the third level watchdog 106. The first response 134a may correspond to the output of the first init process 146. While not explicitly illustrated, the second response 134b, the third response 134c, and the fourth response 134d may be respectively communicated to the second level watchdog 104 via a second init process, a third init process, and a fourth init process. The second init process may be the root init process for a second group of functionalities (e.g., ASIL B functionalities), the third init process may be the root init process for a third group of functionalities (e.g., ASIL C functionalities), and a fourth init process may be the root init process for a fourth group of functionalities (e.g., ASIL D functionalities).

In some embodiments, the response combination module 135 may be configured to combine the responses 134 to generate a response 136. In these and other embodiments, the response combination module 135 may be configured to combine the response 134 in the same manner as the combination module 118 of the first level watchdog 102. For example, in instances the combination module 118 concatenates the modified numbers 117 to generate the expected response 119, the response combination module 135 may concatenate the response 134 in the same manner to generate the response 136.

Additionally or alternatively, the second level watchdog 104 may validate other parts of the kernel that are not associated with the specific processes or functionalities. For example, the second level watchdog 104 may include a watchdog thread 138 configured to periodically run (e.g., as invoked by a scheduler) to validate other parts of the kernel that need periodic validation such as IRQ timeouts. The watchdog thread 138 may generate a validation 139 indicating whether the watchdog thread 138 successfully validated the parts of the kernel. In instances the validation 139 indicates a successful validation, the watchdog thread 138 may cause the response 136 to be sent to the first level watchdog 102. In other instances, in which the validation 139 indicates an unsuccessful validation, the watchdog thread 138 may stop the response 136 from being communicated to the first level watchdog 102, such that the timer 122 expires or lapses. In such instances, the first level watchdog 102 may assume that the source of the issue causing the timer 122 to expire is in the kernel.

Referring back to FIG. 1B, the verification module 120 may be configured to verify the response 136 with respect to the expected response 119. For example, the verification module 120 may utilize the expected response 119 as the ground truth in verifying the response 136 obtained from lower-level watchdogs, such as the second level watchdog 104. In instances the response 136 matches the expected response 119, the verification module 120 may cause the timer 122 to be reloaded or reset, and the random number generator 110 may generate a new random number to be used as a challenge number for next cycle of verification. In instances the response 136 does not match the expected response 119, the timer 122 may be forcefully expired, such that the issue may be identified and resolved.

Modifications, additions, or omissions may be made to FIGS. 1A-1B without departing from the scope of the present disclosure. For example, the multi-level watchdog 100, the first level watchdog 102, the second level watchdog 104, the third level watchdog 106, and/or the fourth level watchdog 108 may include more or fewer elements than those illustrated and described in the present disclosure.

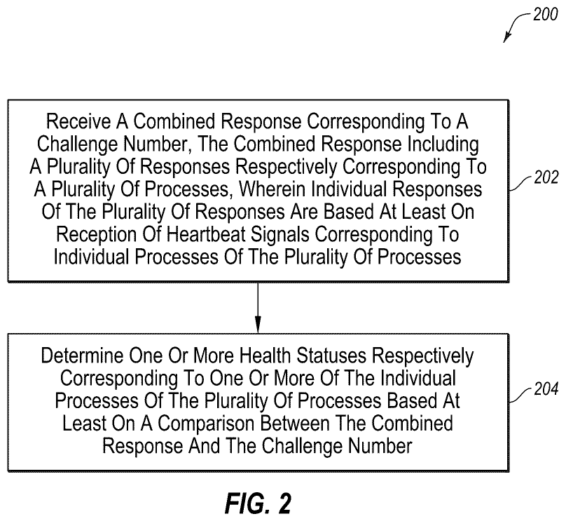

Now referring to FIG. 2, each block of method 200, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, method 200 is described, by way of example, with respect to FIGS. 1A-1E. However, these methods may additionally or alternatively be executed by any one system, or any combination of systems, including, but not limited to, those described herein.

FIG. 2 is a flow diagram showing a method 200 for monitoring machine systems, in accordance with some embodiments of the present disclosure. The method 200, at block 202, may include receiving a combined response corresponding to a challenge number. In some embodiments, the combined response may include a set of responses respectively corresponding to a set of processes, in which individual responses of the set of responses are based at least on reception of heartbeat signals corresponding to individual processes of the set of processes.

In some embodiments, the combined response may be defined based at least on concatenation of the individual responses of the set of responses. For example, each individual response may include a number with a certain number of bits. The numbers may be concatenated to define the combined response. In these and other embodiments, the individual responses may be determined independently such that a first individual response does not affect a second individual response.

In some embodiments, the individual processes may represent processes operating at different safety integrity levels. For example, with respect to automotives, the individual processes may include a first process operating at ASIL A level, a second process operating at ASIL B level, a third process operating at ASIL C level, and a fourth process operating at ASIL D level. In some embodiments, the individual processes may include and/or represent the init processes for each safety integrity level. An init process refers to the root process that is initialized first for the group of processes. For example, one or more child processes may be called from and/or initialized from each init process. The child processes may be configured to send a signal to the init process to indicate the health statuses of the child processes. The init processes and/or the individual processes may be configured to generate the individual responses in response to the individual processes generating heartbeat signals based at least on all child processes sending signals indicating intended operations of the child processes.

In some embodiments, the individual processes may not generate the individual responses in response to not receiving a signal from at least one child process associated with the individual processes. For example, in instances in which the individual processes do not generate the heartbeat signals within a predetermined temporal window, corresponding individual responses may not be generated and/or transmitted. In some embodiments, the individual processes may correspond to init processes such as the first init process 146 of FIG. 1D.

At block 204, the method 200 may include determining one or more health statuses respectively corresponding to one or more of the individual processes of the set of processes based at least on a comparison between the combined response and the challenge number. For example, the top level or the first level watchdog (e.g., the first level watchdog 102 of FIG. 1A) may compare determine the health statuses of the processes based at least on the combined response and the challenge number. In response verifying the intended operations and/or healthy statuses of the processes, the first level watchdog may reset the timer. In response to identifying at least one process that is not operating as intended, the first level watchdog may forcefully expire the timer such that corrective operations may be performed.

In some embodiments, determining the one or more health statuses may include applying a set of functions (e.g., the functions 116 of FIG. 1B) to portions of the challenge number to generate an expected response and comparing the expected response to the combined response. In these and other embodiments, the number of separate portions of the challenge number to apply the functions may correspond to the numbers of individual processes and/or individual responses. For example, in instances the set of responses include four individual responses (e.g., corresponding to ASIL A, ASIL B, ASIL C, and ASIL D), the challenge number may be divided into four distinct portions. A unique and independent function of the set of functions may be applied to a portion of the four distinct portions such that each portion is modified uniquely. The modified portions of the challenge number may be combined in the same manner as the individual responses are combined (e.g., concatenated).

In some embodiments, the challenge number may be a randomly generated number. In these and other embodiments, the random number may be divided into a set of split numbers. The individual functions of the set of functions may be applied to respective individual split numbers of the set of split numbers to generate modified numbers. The modified numbers may be combined to define the expected response.

Additionally, the individual responses may be determined based at least on the challenge number. For example, the challenge number may be divided into distinct portions as same as in generating the expected response. Each portion of the challenge number may be provided to the individual processes. The individual processes may be associated with the same set of functions used to generate the expected responses, such that the individual processes and/or the watchdog mechanisms associated with the individual processes may generate the individual responses corresponding to the expected response.

In some embodiments, determining one or more health statuses may include identifying an individual process associated with a mismatched response with respect to the challenge number. For example, the comparison between the expected response and the combined response may include a mismatch. In such instances, the source and/or cause of the mismatch may be identified. For example, the source may indicate one or more individual responses that do not match the corresponding portion of the expected response.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 3A is an example of sensor locations having corresponding fields of view or sensory fields for an autonomous or semi-autonomous vehicle 300a, an autonomous mobile robot (AMR) 300b, and a humanoid robot 300c, in accordance with some embodiments of the present disclosure. Although three types of machines 300 are illustrated, this is not intended to be limiting, and the machine(s) 300 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 300a, AMR 300b, humanoid robot 300c, and/or other machine types may be referred to herein collectively as machine 300, in some instances.

With respect to vehicles 300A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 300 may be capable of functionality in accordance with one or more of Level 3-Level 5 of the autonomous driving levels. The machine 300 may be capable of functionality in accordance with one or more of Level 1-Level 5 of the autonomous driving levels. For example, the machine 300 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 300 or other machine, such as being fully autonomous, being highly autonomous, being conditionally autonomous, being partially autonomous, providing assistive autonomy, being semi-autonomous, being primarily autonomous, or other designation.

With respect to FIG. 3A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 368D, a 180 degree field of view of a wide-view camera 370, a 360 degree sensory field of a LiDAR sensor 364, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 300a, AMR 300b, and/or humanoid robot 300c, etc. For example, with respect to the vehicle 300a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 300b and/or humanoid robot 300c, the shape, size, purpose, implementation, model, etc. may dictate the number and types of sensors used.

As illustrated in FIG. 1A, the autonomous or semi-autonomous vehicle 300A, the AMR 300B, and the humanoid robot 300C may include different sensor types, number, and locations. For a non-limiting example, the vehicle 300A may include twelve cameras 364, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 364 may use, in embodiments, a gigabit multimedia serial link (GMSL) interface—such as GMSL2—as input/output (I/O).

In some embodiments, although not illustrated in FIG. 3A, the vehicle 300A may include an in-cabin occupant and/or driver monitoring system, that may include various different sensors. For example, the in-cabin sensors may include various cameras 368, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 368, the internal camera(s) 368 may, in embodiments, use a GMSL (such as GMSL2) interface for I/O.

As another non-limiting example, the vehicle 300A may further include nine RADAR sensors 360. For example, the vehicle 300A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 360 may use, in embodiments, an Ethernet interface as I/O.

The vehicle(s) 300A may further include, as a non-limiting example, twelve ultrasonic sensors 362. As illustrated in FIG. 3A, the ultrasonic sensors may be positioned along the front and rear bumpers of the vehicle 300A, and along the side of the vehicle 300A, and may be used to detect objects (static and dynamic) in close proximity to the vehicle 300A. In some embodiments, the ultrasonic sensor(s) 362 may use a DS13 interface as I/O.

The vehicle(s) 300A may further include, as a non-limiting example, a LiDAR sensor 364, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 364 may include a 360 degree horizontal FOV or sensory field (such as in a spinning LiDAR sensor) and a 90 degree vertical FOV or sensory field. In some embodiment, the LiDAR sensor(s) 364 may use an Ethernet interface as I/O.

The autonomous mobile robot (AMR) 300B may include, as a non-limiting example, three LiDAR sensors 364. For example, the top-most illustrated LiDAR sensor 364 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 300B may further include, as a non-limiting embodiment, eight cameras 368, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +−3 degree FOV), a rear fisheye camera (e.g., 202 degree +−3 degree FOV), a left fisheye camera (e.g., 202 degree +−3 degree FOV), and a right fisheye camera (e.g., 202 degree +−3 degree FOV).

The AMR 300B may further include a charging port, charging port contacts, a status indicator light, one or more (e.g., four) RGB LEDs, one or more IMU sensors 366, a magnetometer, and a barometer. The AMR 300B is capable of high-precision time synchronization between sensors using hardware time stamping, and PTP over Ethernet with less than 10 microseconds for sensor acquisition time. The AMR 300B provides simultaneous camera capture across all cameras 368 within 100 microseconds from a single hardware trigger, in embodiments, and can write to disk at 4GB/second for sensor capture to bag writing (e.g., writing to ROSbags for the robot operation system (ROS)). As such, the AMR 300B is capable of running the ROS (such as NVIDIA's Isaac ROS), can be teleoperated (as described herein), can map an environment, and can navigate within an environment using visual cameras 368, LiDARs 364, and/or other sensor types or modalities.

The humanoid robot 300C may include, as a non-limiting example, one LiDAR sensor 364. For example, the LiDAR sensor 364 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 300C may further include, as a non-limiting embodiment, four cameras 368, such as a front stereo camera (e.g., 120 degree FOV), a rear stereo camera (e.g., 120 degree FOV), a front fisheye camera (e.g., 202 degree +−3 degree FOV), and a rear fisheye camera (e.g., 202 degree +−3 degree FOV).

The humanoid robot 300C may further include, as a non-limiting embodiment, four ultrasonic sensors 362, such as a left arm ultrasonic sensor, a right arm ultrasonic sensor, a left leg ultrasonic sensor, and right leg ultrasonic sensor.

The humanoid robot 300C may further include any number of actuators—such as to allow control and maneuverability of joints. For example, the humanoid robot 300C may include actuators that allow for various degrees of freedom (DoF) depending on the design. In a non-limiting embodiment, the humanoid robot 300C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 300C may include position and orientation sensors, such as encoders, gyroscopes, and the like, to determine the position of the robot 300C in space, allowing for location determination and movement tracking. The humanoid robot 300C may include force and pressure sensors, in embodiments, to detect environment interactions, allowing the robot 300C to grasp objects with the right force and to avoid obstacles along the way. The perception sensors (e.g., cameras, LiDARs, RADARs, ultrasonic, SONAR, etc.) may be used along with tactile sensors to allow the robot 300C to perceive objects, shapes, and textures, and to understand when touch is initiated and stopped (along with force sensors that regulate the force used during touch). As a non-limiting example, the humanoid robot 300C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 300C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 300C may use onboard sensors, microphones, and speakers to understanding speech, audio and visual cues, etc., while also being able to communicate back to the environment.

With reference to cameras 368 of the machine(s) 300, the camera types for the cameras 368 may include, but are not limited to, digital cameras that may be adapted for use with the components and/or systems of the machine 300. For a vehicle 300a implementation, the camera(s) 368 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 300 (e.g., front-facing cameras) may be used for surround view, to help identify forward facing paths and obstacles, as well aid in, with the help of one or more controllers 336 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 368B that may be used to perceive objects coming into view from the periphery (e.g., pedestrians, warehouse vehicles, other robots, crossing traffic, or bicycles). In addition, any number of long-range camera(s) 368E (e.g., a long-view stereo camera pair) may be used for depth-based object detection, especially for objects for which a neural network has not yet been trained. The long-range camera(s) 368E may also be used for object detection and classification, as well as basic object tracking.

Any number of stereo cameras 368A may also be included in a front-facing and/or other (e.g., rear-facing) configuration. In at least one embodiment, one or more of stereo camera(s) 368A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 300 environment, including a distance estimate for points in the image (e.g., a disparity or depth image). An alternative stereo camera(s) 368A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 368A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 300 (e.g., side-view cameras) may be used, for example, for surround view, providing information used to create and update the occupancy grid, as well as to generate side impact collision warnings and/or to indicate to an AMR 300B or humanoid robot 300C, for example, that there are objects, features, and/or persons present to the side. For example, surround camera(s) 368D may be positioned on the machine 300. The surround camera(s) 368D may include wide-view camera(s) 368B, fisheye camera(s), 360 degree camera(s), and/or the like. For example, four fisheye cameras may be positioned on the machine's 300 front, rear, and sides. In an alternative arrangement, the machine 300 may use three surround camera(s) 368D (e.g., left, right, and rear), and may leverage one or more other camera(s) (e.g., a forward-facing camera) as a fourth surround view camera.

Cameras 368 with a field of view that include portions of the environment to the rear of the machine 300 (e.g., rear-view cameras) may be used for gaining an understanding of objects, features, persons, and/or other information to the rear of the machine 300, such as for park assistance, surround view, rear collision warnings, planning, control, and navigation determinations, and/or creating and updating an occupancy grid, BEV image representing the environment, height map, etc. A wide variety of cameras 368 may be used including, but not limited to, cameras 368 that are also suitable as a front-facing camera(s) (e.g., long-range and/or mid-range camera(s) 368E, stereo camera(s) 368A), infrared camera(s) 368C, etc.), rear-facing camera(s), side-facing camera(s), downward facing camera(s), upward facing camera(s), and/or the like, as described herein.

Similarly, for LiDAR sensors 364, RADAR sensors 360, ultrasonic sensors 362, and/or other sensor modalities or types, the location and placement of the sensors, and their corresponding fields of view or sensory fields may be determined based on the use case, implementation, or design of the particular machine 300.

For example, the machine(s) 300 include RADAR sensor(s) 360 that may be used by the machine 300 for long-range object detection, even in darkness and/or severe weather conditions. RADAR functional safety levels may be ASIL B, in embodiments. The RADAR sensor(s) 360 may use the CAN and/or the bus 302 (e.g., to transmit data generated by the RADAR sensor(s) 360) for control and to access object tracking data, with access to Ethernet to access raw data in some examples. A wide variety of RADAR sensor types may be used. For example, and without limitation, the RADAR sensor(s) 360 may be suitable for front, rear, and side RADAR use. In some example, Pulse Doppler RADAR sensor(s) are used.

The RADAR sensor(s) 360 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 360 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 300 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 360 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 300 (e.g., vehicle, robot, etc.). As such, short-range RADAR systems may be used in an ADAS system for blind spot detection and/or lane change assist.

The machine 300 may further include ultrasonic sensor(s) 362. The ultrasonic sensor(s) 362, which may be positioned at the front, back, and/or the sides of the machine 300, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 300. A wide variety of ultrasonic sensor(s) 362 may be used, and different ultrasonic sensor(s) 362 may be used for different ranges of detection (e.g., 2.5 m, 4 m). The ultrasonic sensor(s) 362 may operate at functional safety levels of ASIL B, as an example.

The machine 300 may include LiDAR sensor(s) 364. The LiDAR sensor(s) 364 may be used for object and feature detection, pedestrian and other robot detection, emergency braking, collision avoidance, simultaneous localization and mapping (SLAM), free-space detection, and/or other functions. The LiDAR sensor(s) 364 may be functional safety level ASIL B, in embodiments. In some examples, the machine 300 may include multiple LiDAR sensors 364 (e.g., two, four, six, etc.) that may use Ethernet (e.g., to provide data to a Gigabit Ethernet switch).

In some examples, the LiDAR sensor(s) 364 may be capable of providing a list of objects and their distances for a 360-degree field of view. Commercially available LiDAR sensor(s) 364 may have an advertised range of approximately 300 m, with an accuracy of 2 cm-3 cm, and with support for a 300 Mbps Ethernet connection, for example. In some examples, one or more non-protruding LiDAR sensors 364 may be used. In such examples, the LiDAR sensor(s) 364 may be implemented as a small device that may be embedded into the front, rear, sides, top, and/or corners of the machine 300. The LiDAR sensor(s) 364, in such examples, may provide up to a 120-degree horizontal and 35-degree vertical field-of-view, with a 200 m range even for low-reflectivity objects. Front-mounted LiDAR sensor(s) 364 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 300. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 364 may be less susceptible to motion blur, vibration, and/or shock.

FIG. 3B is an illustration of sensor and component locations of an example autonomous or semi-autonomous vehicle 300A (alternatively referred to herein as “vehicle 300,” “ego-vehicle 300,” “ego-machine 300,” or “machine 300,”), in accordance with some embodiments of the present disclosure. Although the vehicle 300A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 3C is a block diagram of an example system architecture for a machine 300, such as autonomous or semi-autonomous vehicle 300A, autonomous mobile robot (AMR) 300B, humanoid robot 300C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 300 of FIGS. 3A-3E, example computing ecosystem 400 of FIG. 4, example generative language model system 500 of FIG. 5, and/or example computing device 600 of FIG. 6.

Each of the components, features, and systems of the machine 300 in FIG. 3C are illustrated as being connected via bus 302 (alternatively referred to as a “machine communications network 302,” or just “communications network 302”). The bus 302 may include a Controller Area Network (CAN) data interface (alternatively referred to herein as a “CAN bus”). A CAN may be a network inside the machine 300 used to aid in control of various features and functionality of the machine 300, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 302 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 302, this is not intended to be limiting. For example, there may be any number of busses 302, which may include one or more CAN busses, one or more FlexRay busses, one or more Ethernet busses, and/or one or more other types of busses using a different protocol. In some examples, two or more busses 302 may be used to perform different functions, and/or may be used for redundancy. For example, a first bus 302 may be used for collision avoidance functionality and a second bus 302 may be used for actuation control. In any example, each bus 302 may communicate with any of the components of the machine 300, and two or more busses 302 may communicate with the same components. In some examples, each SoC 304, each controller 336, and/or each computer or compute engine within the machine 300 may have access to the same input data (e.g., inputs from sensors of the machine 300), and may be connected to a common bus, such as a CAN bus.

The machine 300 may include components such as a chassis, a vehicle body, wheels (e.g., 2, 4, 6, 8, 18, etc.), tires, axles, batteries, side-view mirrors, and/or other components of a vehicle or machine. The machine 300 may include a propulsion system 350, such as an internal combustion engine, hybrid electric power plant, an all-electric engine, a hydrogen-fueled engine, and/or another propulsion system type. The propulsion system 350 may be connected to a drive train of the machine 300, which may include a transmission, to enable the propulsion of the machine 300. The propulsion system 350 may be controlled in response to receiving signals from the throttle/accelerator 352.

A steering system 354, which may include a steering wheel and/or other steering device (e.g., remote steering and/or local steering), may be used to steer the machine 300 (e.g., along a desired path or route) when the propulsion system 350 is operating (e.g., when the vehicle is in motion). The steering system 354 may receive signals from a steering actuator 356. In some embodiments, a steering wheel or other steering mechanism may not be included, such as for a machine 300 capable of full automation (e.g., Level 5) functionality.

The brake sensor system 346 may be used to operate the vehicle brakes in response to receiving signals from the brake actuators 348 and/or brake sensors.

The machine 300 may include one or more controller(s) 336, such as those described herein with respect to FIG. 3A. The controller(s) 336 may be used for a variety of functions, and may be coupled to any of the various other components and systems of the machine 300. For example, the controllers 336 may be used for control of the machine 300, artificial intelligence executing on the machine 300, infotainment for the machine 300, and/or the like. For example, one controller 336 may be used for some or all of the functionality, or different controllers 336 may be used for different functionalities—e.g., to ensure availability and a safety separation between various controllers for different tasks. For example, the controller(s) 336 may use plans computed by the system—e.g., paths or trajectories for vehicles 300A or AMRs 300B, or movements, components trajectories, movement locations or displacements, etc. for joints or components (e.g., of manipulators, end effectors, limbs, hands, fingers, legs, feet, etc.), of a humanoid robot 300C—to control the machine(s) 300 in the environment. In some instances, the controller(s) 336 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 300C, for example, the controller(s) 336 may act as the brain, responsible for analyzing sensor data, making decisions, and sending commands to the actuators. The controller(s) 336 may include a low-level controller that handles basic motor control, ensuring accurate and precise movements of individual joints and actuators. The controller(s) 336 may include a high-level controller to coordinate multiple actuators and sensors, planning complex motions and adapting to changing environments.

The controller(s) 336 may include an artificial intelligence controller, in embodiments, that may use AI algorithms (e.g., DNNs, MLMs, etc.) to learn, make decisions, and autonomously perform tasks for the machine 300. In some embodiments, the controller(s) 336 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 336 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 336, which may include one or more systems on chip (SoCs) 304 (FIGS. 3C and 3D), CPUs, GPU(s), accelerator(s), etc., may provide signals (e.g., representative of commands or messages) to one or more components and/or systems of the machine 300. Although the controller(s) 336 is listed separately from the SoC(s) 304, this is not intended to be limiting, and in some embodiments one or more components of the SoC(s) 304 may perform the operations of the controller(s) 336. For example, the controller(s) may send signals to operate the machine brakes via one or more brake actuators 348, to operate the steering system 354 via one or more steering actuators 356, to operate the propulsion system 350 via one or more throttle/accelerators 352, etc. The controller(s) 336 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 300. The controller(s) 336 may include a first controller 336 for autonomous control and navigation functions, a second controller 336 for functional safety functions, a third controller 336 for artificial intelligence functionality (e.g., computer vision), a fourth controller 336 for infotainment functionality, a fifth controller 336 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 336 may handle two or more of the above functionalities, two or more controllers 336 may handle a single functionality, and/or any combination thereof.

The controller(s) 336 may provide the signals for controlling one or more components and/or systems of the machine 300 in response to sensor data received from one or more sensors (e.g., sensor inputs). The sensor data may be received from, for example and without limitation, global navigation satellite systems (“GNSS”) sensor(s) 358 (e.g., Global Positioning System sensor(s)), RADAR sensor(s) 360, ultrasonic sensor(s) 362, LiDAR sensor(s) 364, inertial measurement unit (IMU) sensor(s) 366 (e.g., accelerometer(s), gyroscope(s), magnetic compass(es), magnetometer(s), etc.), microphone(s) 396, camera(s) 368 (e.g., stereo camera(s) 368A, wide-view camera(s) 368B (e.g., fisheye cameras), infrared camera(s) 368C, surround camera(s) 368D (e.g., 360 degree cameras), long-range and/or mid-range camera(s) 368E, and/or other camera types), speed sensor(s) 344 (e.g., for measuring the speed of the machine 300), vibration sensor(s) 342, steering sensor(s) 340, brake sensor(s) (e.g., as part of the brake sensor system 346), actuators, and/or other sensor types.

One or more of the controller(s) 336 may receive inputs (e.g., represented by input data) from an instrument cluster 332 of the machine 300 and provide outputs (e.g., represented by output data, display data, etc.) via a human-machine interface (HMI) display 334 (e.g., screen, heads-up display, mirror display, facial display, robotic display, etc.), an audible annunciator, a loudspeaker, a speaker, and/or via other components of the machine 300. The outputs may include information such as machine velocity, speed, time, map data corresponding to a map(s) 322 of FIG. 3C (e.g., from a navigation map, a Standard Definition (SD) map, a High Definition (“HD”) map, etc.), location data (e.g., the machine's 300 location, such as on a map 322), direction, location of other vehicles (e.g., an occupancy map, height map, bird's eye view (BEV) image, grid, etc.), information about objects and status of objects as perceived by the system, system status information, etc. For example, the HMI display(s) 334 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 300 may include one or more systems on a chip (SoCs) 304 (described in more detail in FIG. 3D). The SoC(s) 304 may include CPU(s) 306, GPU(s) 308, processor(s) 310, cache(s) 312, accelerator(s) 314, data store(s) 316, and/or other components and features. The SoC(s) 304 may be used to process and provide data for various operations, such as navigation, planning, reasoning, inference, perception, control, and/or actuation operations of the machine 300 in a variety of platforms and systems. For example, the SoC(s) 304 may process live perception data (e.g., from camera, LiDAR, RADAR, ultrasonic, etc.) in addition to map data corresponding to one or more maps 322 (e.g., HD map, SD map, navigational map, occupancy map, etc.) in order to make or aid in performing various operations of the machine 300. Where a map and/or AI is used, map and/or AI (e.g., model parameter updates, fine-tuning, etc.) refreshes and/or updates via a network interface 324 from one or more servers (e.g., server(s) 378 of FIG. 3E)—such as one or more servers of a cloud-based data center.

Although an SoC(s) 304 is illustrated throughout FIGS. 3A-3E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)-without departing from the scope of the present disclosure. For example, depending on the type of machine 300, use of the machine 300, model of the machine 300, and required capabilities of the machine 300, one or more SoCs 304 and/or alternative architectures and/or components may be used to satisfy the particular implementation.

The machine 300 may include a CPU(s) 318 (e.g., discrete CPU(s), or dCPU(s)), that may be coupled to the SoC(s) 304 via a high-speed interconnect (e.g., PCIe). The CPU(s) 318 may include an X86 processor, for example. The CPU(s) 318 may be used to perform any of a variety of functions, including arbitrating potentially inconsistent results between ADAS sensors and the SoC(s) 304, and/or monitoring the status and health of the controller(s) 336 and/or infotainment SoC 330, for example.

The machine 300 may include a GPU(s) 320 (e.g., discrete GPU(s), or dGPU(s)), that may be coupled to the SoC(s) 304 via a high-speed interconnect (e.g., NVIDIA's NVLink). The GPU(s) 320 may provide additional artificial intelligence functionality, such as by executing redundant and/or different neural networks, and may be used to train and/or update neural networks based on input (e.g., sensor data) from sensors of the machine 300.

The machine 300 may further include the network interface 324 which may include one or more wireless antennas 326 and/or modems (e.g., one or more wireless antennas for different communication protocols, such as a cellular antenna, a Bluetooth antenna, etc.). The network interface 324 may be used to enable wireless connectivity over the Internet with the cloud (e.g., with the server(s) 378 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 300 information about vehicles in proximity to the machine 300 (e.g., vehicles in front of, on the side of, and/or behind the machine 300). This functionality may be part of a cooperative adaptive cruise control functionality of the machine 300.

The network interface 324 may include a SoC that provides modulation and demodulation functionality and enables the controller(s) 336 to communicate over wireless networks. The network interface 324 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 324 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 326 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 300 may further include data store(s) 328 which may include off-chip (e.g., off the SoC(s) 304) storage. The data store(s) 328 may include one or more storage elements including RAM, SRAM, DRAM, VRAM, Flash, hard disks, and/or other components and/or devices that may store at least one bit of data.

The machine 300 may further include GNSS sensor(s) 358. The GNSS sensor(s) 358 (e.g., GPS, assisted GPS sensors, differential GPS (DGPS) sensors, etc.), to assist in mapping, perception, occupancy grid generation, and/or path planning functions. Any number of GNSS sensor(s) 358 may be used, including, for example and without limitation, a GPS using a USB connector with an Ethernet to Serial (RS-232) bridge.

The machine 300 may further include IMU sensor(s) 366. The IMU sensor(s) 366 may be located at a center of the rear axle of the machine 300, in some examples. The IMU sensor(s) 366 may include, for example and without limitation, an accelerometer(s), a magnetometer(s), a gyroscope(s), a magnetic compass(es), and/or other sensor types. In some examples, such as in six-axis applications, the IMU sensor(s) 366 may include accelerometers and gyroscopes, while in nine-axis applications, the IMU sensor(s) 366 may include accelerometers, gyroscopes, and magnetometers.

In some embodiments, the IMU sensor(s) 366 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 366 may enable the machine 300 to estimate heading without requiring input from a magnetic sensor by directly observing and correlating the changes in velocity from GPS to the IMU sensor(s) 366. In some examples, the IMU sensor(s) 366 and the GNSS sensor(s) 358 may be combined in a single integrated unit.

The vehicle may include one or more microphone 396 placed in and/or around the machine 300. The microphone(s) 396 may be used for emergency vehicle detection and identification, among other things.

The machine 300 may further include vibration sensor(s) 342. The vibration sensor(s) 342 may measure vibrations of components of the machine, such as the arms or legs of a humanoid robot 300C, or the axle(s) of a vehicle 300A or AMR 300B. For example, changes in vibrations may indicate a change in road, walking, or traversable surfaces. In another example, when two or more vibration sensors 342 are used, the differences between the vibrations may be used to determine friction or slippage of the surface (e.g., when the difference in vibration is between a power-driven axle and a freely rotating axle).

The machine 300 may include an ADAS system 338—such as when the machine 300 is a vehicle 300A. The ADAS system 338 may include a dedicated SoC(s), in some examples. The ADAS system 338 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 300 may further include the infotainment SoC 330 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 330 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 300. For example, the infotainment SoC 330 may radios, disk players, navigation systems, video players, USB and Bluetooth connectivity, carputers, in-car entertainment, Wi-Fi, steering wheel audio controls, hands free voice control, a heads-up display (HUD), an HMI display 334, a telematics device, a control panel (e.g., for controlling and/or interacting with various components, features, and/or systems), and/or other components. The infotainment SoC 330 may further be used to provide information (e.g., visual and/or audible) to a user(s) of the vehicle, such as information from the ADAS system 338, autonomous driving information such as planned vehicle maneuvers, trajectories, surrounding environment information (e.g., intersection information, vehicle information, road information, etc.), and/or other information.

The infotainment SoC 330 may include GPU functionality. The infotainment SoC 330 may communicate over the bus 302 (e.g., CAN bus, Ethernet, etc.) with other devices, systems, and/or components of the machine 300. In some examples, the infotainment SoC 330 may be coupled to a supervisory MCU such that the GPU of the infotainment system may perform some self-driving functions in the event that the primary controller(s) 336 (e.g., the primary and/or backup computers of the machine 300) fail. In such an example, the infotainment SoC 330 may put the machine 300 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 300—whether a vehicle 300A, AMR 300B, humanoid robot 300C, and/or other type of machine—may include a locally stored language model(s) and/or communicate to a remotely hosted language model (e.g., via one or more APIs) to provide more detailed and in-depth communication features to the users of the machine(s) 300.

In some examples, an infotainment SoC 330, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 300. The always on sensor processing engine may be used to unlock the vehicle when the owner approaches the driver door and turn on the lights, and, in security mode, to disable the vehicle when the owner leaves the vehicle. In this way, the SoC(s) 304 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 300.

The machine 300 may further include an instrument cluster 332 (e.g., a digital dash, an electronic instrument cluster, a digital instrument panel, etc.). The instrument cluster 332 may include a controller and/or supercomputer (e.g., a discrete controller or supercomputer). The instrument cluster 332 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 330 and the instrument cluster 332. In other words, the instrument cluster 332 may be included as part of the infotainment SoC 330, or vice versa.

FIG. 3D is a block diagram of an example architecture of a computing system (a subset of the system described with respect to FIG. 3C), in accordance with at least some embodiments of the present disclosure. Although illustrated as an SoC(s) 304, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 304 may be an end-to-end platform with a flexible architecture that spans automation levels 2-5, or the SoC(s) 304 may be specifically designed for a specific automation level (e.g., a first SoC 304 for level 2 to level 2++, a second SoC 304 for level 3, a third SoC 304 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 304 may be faster, more reliable, and even more energy-efficient and space-efficient than conventional systems. For example, the accelerator(s) 314, when combined with the CPU(s) 306, the GPU(s) 308, and the data store(s) 316, may provide for a fast, efficient platform for level 2-5 autonomous vehicles as well as for safe planning, navigation, and control of AMRs 300B, humanoid robots 300C, and/or other robot or machine types.

In some embodiments, such as where the SoC(s) 304 include a GPU 308 with 2000 or more cores (e.g., 2048 cores), 60 or more tensor cores (e.g., 64 tensor cores), and a GPU max frequency of over 1 GHz (e.g., 1.3 GHz), a CPU 306 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 309 (e.g., 2 DLAs/XNNs/NNAs/NPUs 309), and a vision accelerator—such as a programmable vision accelerator (PVA) 307, a single SoC 304) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 304 include a GPU 308 with 1700 or more cores (e.g., 1792 cores), 50 or more tensor cores (e.g., 56 tensor cores), and a GPU max frequency of over 900 MHz (e.g., 930 MHz), a CPU 306 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 309 (e.g., 2 DLAs/XNNs/NNAs/NPUs 309), and a vision accelerator—such as a programmable vision accelerator (PVA) 307, a single SoC 304) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 304 include a GPU 308 with 1000 or more cores (e.g., 1024 cores), 28 or more tensor cores (e.g., 32 tensor cores), and a GPU max frequency of over 900 MHz (e.g., 1173 MHz), a CPU 306 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 309 (e.g., 1 DLA/XNN/NNA/NPU 309), and a vision accelerator—such as a programmable vision accelerator (PVA) 307, a single SoC 304) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 304 include a GPU 308 with 1000 or more cores (e.g., 1024 cores), 28 or more tensor cores (e.g., 32 tensor cores), and a GPU max frequency of over 900 MHz (e.g., 1020 MHz), a CPU 306 including 6 or more cores (e.g., 6 cores), with 64 bits, 1.5 MB L2 and 4 MB L3 cache memory, and a max frequency of 1.5 or more GHz (e.g., 1.7 GHz), a single SoC 304) may be capable of 67 tera operations per second (TOPS) of AI performance. For example, NVIDIA's Jetson Orin Nano 8 GB SoC satisfies these criteria, and achieves this performance.

The SoC(s) 304 may include one or more CPUs 306. The CPU(s) 306 may include a CPU cluster or CPU complex (alternatively referred to herein as a “CCPLEX”), in embodiments. The CPU(s) 306 may include multiple cores and/or (e.g., L2, L3) caches. For example, in some embodiments, the CPU(s) 306 may include twelve cores in a coherent multi-processor configuration. In some embodiments, the CPU(s) 306 may include four dual-core clusters where each cluster has a dedicated L2 cache (e.g., a 3 MB L2 cache). The CPU(s) 306 (e.g., the CCPLEX) may be configured to support simultaneous cluster operation enabling any combination of the clusters of the CPU(s) 306 to be active at any given time.

The SoC(s) 304 may include any type and number of GPUs 308. For example, an integrated GPU(s) (alternatively referred to herein as an “iGPU(s)”) may be used in some embodiments. The GPU(s) 308 may be programmable and may be efficient for parallel workloads. The GPU(s) 308, in some examples, may use an enhanced tensor instruction set. The GPU(s) 308 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 308 may include at least eight streaming microprocessors. The GPU(s) 308 may use compute application programming interface(s) (API(s)). In addition, the GPU(s) 308 may use one or more parallel computing platforms and/or programming models (e.g., NVIDIA's CUDA).

The GPU(s) 308 may be power-optimized for best performance in automotive, robotics, and/or other embedded use cases. For example, the GPU(s) 308 may be fabricated on a Fin field-effect transistor (FinFET). However, this is not intended to be limiting and the GPU(s) 308 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 308 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 308 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 308 to access the CPU(s) 306 page tables directly. In such examples, when the GPU(s) 308 memory management unit (MMU) experiences a miss, an address translation request may be transmitted to the CPU(s) 306. In response, the CPU(s) 306 may look in its page tables for the virtual-to-physical mapping for the address and transmits the translation back to the GPU(s) 308. As such, unified memory technology may allow a single unified virtual address space for memory of both the CPU(s) 306 and the GPU(s) 308, thereby simplifying the GPU(s) 308 programming and porting of applications to the GPU(s) 308.

The SoC(s) 304 may include any number of cache(s) 312, including those described herein. For example, the cache(s) 312 may include L0 caches, L1 caches, L2 caches, L3 caches (e.g., that are available to both the CPU(s) 306 and the GPU(s) 308 (e.g., that is connected both the CPU(s) 306 and the GPU(s) 308)), etc. The cache(s) 312 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 304 may include one or more arithmetic logic units (ALUs) 365 which may be leveraged in performing processing with respect to any of the variety of tasks or operations of the machine 300—such as computer vision, machine learning or deep learning processing, world model management, etc. In addition, the SoC(s) 304 may include a floating point unit(s) (FPU(s)) 367—or other math coprocessor or numeric coprocessor types-for performing mathematical operations within the system. For example, the SoC(s) 104 may include one or more FPUs 367 integrated as execution units within a CPU(s) 306 and/or GPU(s) 308.

The SoC(s) 304 may include one or more accelerators 314 (e.g., hardware accelerators, software accelerators, or a combination thereof). For example, the SoC(s) 304 may include a hardware acceleration cluster that may include optimized hardware accelerators and/or large on-chip memory. The large on-chip memory 315 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 308 and to off-load some of the tasks of the GPU(s) 308 (e.g., to free up more cycles of the GPU(s) 308 for performing other tasks). As an example, the accelerator(s) 314 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 314 (e.g., the hardware acceleration cluster) may include a deep learning accelerator(s) (DLA) 309 (alternatively referred to herein as “a deep learning accelerator cluster (XNN) 309,” “neural network accelerator (NNA) 309,” or “neural processing unit (NPU) 309”). The DLA(s) 309 may include one or more Tensor processing units (TPUs) 341 that may be configured to provide an additional, e.g., ten trillion operations per second for deep learning applications and inferencing. The TPUs 341 may be accelerators configured to, and optimized for, performing image processing functions (e.g., for CNNs, RCNNs, DNNs, etc.). The DLA(s) 309 may further be optimized for a specific set of neural network types and floating point operations, as well as inferencing. The design of the DLA(s) may provide more performance per millimeter than a general-purpose GPU, and vastly exceeds the performance of a CPU. The TPU(s) 341 may perform several functions, including a single-instance convolution function, supporting, for example, INT8, INT16, and FP16 data types for both features and weights, as well as post-processor functions. Although the TPU(s) 341 are described as being included as part of the DLA(s) 309, this is not intended to be limiting, and the TPU(s) 341 may be included in additional or alternative accelerator(s) 314 and/or other components, and/or may be included as a discrete processing component(s).

The DLA(s) 309 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 309 may perform any function of the GPU(s) 308, and by using an inference accelerator, for example, a designer may target either the DLA(s) 309 or the GPU(s) 308 for any function. For example, the designer may focus processing of DNNs and floating point operations on the DLA(s) 309 and leave other functions to the GPU(s) 308 and/or other accelerator(s) 314. The DLA(s) 309 may be used to run any type of network to enhance control and safety, including for example, a neural network that outputs a measure of confidence for each object detection.

The accelerator(s) 314 (e.g., the hardware acceleration cluster) may include a programmable vision accelerator(s) (PVA) 307, which may alternatively be referred to herein as a computer vision accelerator or generally a vision accelerator. The PVA(s) 307 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 307 may provide a balance between performance and flexibility. For example, each PVA(s) 307 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 307 may be optimized for the tasks of image processing and computer vision algorithm acceleration. For example, the PVA(s) 307 provides excellent performance with extremely low power consumption, and can be used asynchronously and concurrently with the CPU(s) 306, GPU(s) 308, and/or other accelerators in the system (e.g., vehicle, robot, etc.) as part of a heterogeneous compute pipeline.

The PVA(s) 307 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 343 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts—ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 306 (e.g., ARM Cortex-R5 processor), facilitating data exchange with the CPU(s) 306 and other system-level components. The VPU I-cache may supply instruction data to the VPU(s) when requested, may request missing instruction data from system memory, and/or may maintain temporary instruction storage for the VPU. For each VPU task, the CPU(s) 306 may configures the DMA system, optionally prefetch the VPU program into VPU I-cache, and/or kick off each VPU-DMA pair to process a task. The PVA(s) 307 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 307 to access the system memory independently of the CPU(s) 306. The DMA may support any number of features used to provide optimization to the PVA(s) 307 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 307 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 307, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 307 may be configured to employ data parallelism. For example, in some embodiments, the plurality of vector processors included in a single PVA(s) 307 may execute the same computer vision algorithm, but on different regions of an image. In other examples, the vector processors included in a particular PVA(s) 307 may simultaneously execute different computer vision algorithms, on the same image, or even execute different algorithms on sequential images or portions of an image. Among other things, any number of PVAs 307 may be included in the hardware acceleration cluster and any number of vector processors may be included in each of the PVAs. In addition, the PVA(s) 307 may include additional error correcting code (ECC) memory, to enhance overall system safety.

The accelerator(s) 314 (e.g., the hardware accelerator cluster) have a wide array of uses for autonomous and semi-autonomous machine control. The PVA(s) 307 may be a programmable vision accelerator that may be used for key processing stages in perception, robotics understanding and reasoning, ADAS, semi-autonomous, and autonomous vehicles, etc. The PVA's 307 capabilities are a good match for algorithmic domains needing predictable processing, at low power and low latency. In other words, the PVA(s) 307 performs well on semi-dense or dense regular computation, even on small data sets, which need predictable run-times with low latency and low power. Thus, in the context of platforms for autonomous vehicles and robotics, the PVAs 307 are designed to run classic computer vision algorithms, as they are efficient at object detection and operating on integer math.

For example, according to one embodiment of the technology, the PVA 307 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 307 may perform computer stereo vision function on inputs from two monocular cameras.

In some examples, the PVA(s) 307 may be used to perform dense optical flow. According to process raw RADAR data (e.g., using a 4D Fast Fourier Transform) to provide Processed RADAR. In other examples, the PVA(s) 307 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 307, this is not intended to be limiting. In some embodiments, these components may be included in alternative or additional processing components and/or accelerator(s) 314, and/or may be included as discrete components of the SoC(s) 304 and/or other computing system architecture(s).

In some examples, the SoC(s) 304 may include a real-time ray-tracing hardware accelerator (RTA) 351 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 300 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 351 and/or a ray-tracing optimized GPU 306—such as NVIDIA's RTX GPU.

The accelerator(s) 314 (e.g., in the hardware acceleration cluster) may include one or more optical flow accelerators (OFAs) 311. For example, the OFA(s) 311 may be used for computing optical flow and stereo disparity between frames of sensor data (e.g., images). Optical flow may be accelerated on the OFA(s) 311 for uses such as object detection and tracking, and/or for stereo depth estimation where used for computing stereo disparity between stereo image frames (e.g., two or more frames captured using two or more image sensors with at least partially overlapping fields of view).

The SoC(s) 304 may include one or more camera serial interfaces (CSIs) 323. For example, the CSI(s) 323 may include a mobile industry processor interface (MIPI) camera serial interface (CSI) for receiving video and input from cameras, a high-speed interface, and/or a video input block that may be used for camera and related pixel input functions. The SoC(s) 304 may further include an input/output controller(s) that may be controlled by software and may be used for receiving I/O signals that are uncommitted to a specific role. For example, the CSI 323 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 314 (e.g., the hardware acceleration cluster) may include a computer vision network on-chip (CVNOC) 363 and SRAM, for providing a high-bandwidth, low latency SRAM for the accelerator(s) 314. In some examples, the on-chip memory may include at least 4 MB SRAM, consisting of, for example and without limitation, eight field-configurable memory blocks, that may be accessible by the PVA 307, OFA 311, DLA 309, and/or other accelerator(s) 314. Each pair of memory blocks may include an advanced peripheral bus (APB) interface, configuration circuitry, a controller, and a multiplexer. Any type of memory 315 may be used. The PVA 307, OFA 311, DLA 309, and/or other accelerator(s) 314 may access the memory via a backbone that provides the accelerator(s) 314 with high-speed access to memory. The backbone may include a computer vision network on-chip that interconnects the accelerator(s) 314 to the memory (e.g., using the APB).

The CVNOC 363 may include an interface that determines, before transmission of any control signal/address/data, that the accelerator(s) 314 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 304 may include data store(s) 316 and/or memory 315. The data store(s) 316 may be on-chip memory 315 of the SoC(s) 304, which may store neural networks and/or other algorithms to be executed on the CPU(s) 306, the GPU(s) 308, and/or one or more of the accelerator(s) 314. In some examples, the data store(s) 316 may be large enough in capacity to store multiple instances of neural networks for redundancy and safety. The data store(s) 312 may comprise L2 and/or L3 cache(s) 312, for example. The memory(ies) 315 may include SRAM, LPDDR5, and/or other memory types. For example, the memory(ies) 315 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 316 may include reference to the memory associated with the PVA 307, OFA 311, DLA 309, and/or other accelerator(s) 314, as described herein.

The data store(s) 116 may include various storage types, such as eMMC, NVMe, etc. For example, the SoC(s) 304 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 316 and/or other storage may be accessed via, e.g., NVMe, using PCI Express (PCIe), RDMA, TCP, and/or other protocols.

The SoC(s) 304 may include one or more processor(s) 310 (e.g., embedded processors). The processor(s) 310 may include a boot and power management processor (BPMP) 353, that may be a dedicated processor and subsystem to handle boot power and management functions and related security enforcement. The BPMP 353 may be a part of the SoC(s) 304 boot sequence and may provide runtime power management services. The BPMP 353 may provide clock and voltage programming, assistance in system low power state transitions, management of SoC(s) 304 thermals and temperature sensors, and/or management of the SoC(s) 304 power states. Each temperature sensor may be implemented as a ring-oscillator whose output frequency is proportional to temperature, and the SoC(s) 304 may use the ring-oscillators to detect temperatures of the CPU(s) 306, GPU(s) 308, accelerator(s) 314, and/or other components. If temperatures are determined to exceed a threshold, BPMP 353 may enter a temperature fault routine and put the SoC(s) 304 into a lower power state and/or put the machine 300 into a chauffeur to safe stop mode (e.g., bring the machine 300 to a safe stop).

The processor(s) 310 may further include a set of embedded processors that may serve as an audio processing engine (APE) 355. The APE 355 may be an audio subsystem that enables full hardware support for multi-channel audio over multiple interfaces, and a broad and flexible range of audio I/O interfaces. In some examples, the APE 355 is a dedicated processor core with a digital signal processor with dedicated RAM.

The processor(s) 310 may further include an always on processor engine (AOPE) 357 that may provide necessary hardware features to support low power sensor management and wake use cases. The AOPE 357 may include a processor core, a tightly coupled RAM, supporting peripherals (e.g., timers and interrupt controllers), various I/O controller peripherals, and routing logic.

The processor(s) 310 may further include a safety processor(s) 313 (alternatively referred to as “safety island 313”), which may include a safety cluster engine that includes a dedicated processor or processor subsystem to handle safety management for automotive, robotics, and/or other applications. The safety processor(s) 313—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 313 may include a discrete processor(s), such that fault of other system components may not impact the performance and availability of the safety processor 313.

The processor(s) 310 may further include a real-time or near real-time sensor engine (SE) 359 that may include a dedicated processor subsystem for handling real-time or near real-time camera, LiDAR, RADAR, and/or other sensor modality management.

The processor(s) 310 may further include one or more image signal processors (ISPs) 327, which may include a high-dynamic range signal processor and/or a hardware engine that is part of one or more sensor processing pipelines.

The processor(s) 310 may include a video image compositor (VIC) 361 that may be a processing block (e.g., implemented on a microprocessor) that implements video post-processing functions needed by a video playback application to produce the final image for the player window. The VIC 361 may perform lens distortion correction on wide-view camera(s) 368B, surround camera(s) 368D, in-cabin monitoring camera sensors, and/or other camera sensors with distorted fields of view.

A VIC 361 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 361 may also be configured to perform stereo rectification on input stereo lens frames. The video image compositor may further be used for user interface composition when the operating system desktop is in use, and the GPU(s) 308 is not required to continuously render new surfaces. Even when the GPU(s) 308 is powered on and active doing 3D rendering, the video image compositor may be used to offload the GPU(s) 308 to improve performance and responsiveness.

The SoC(s) 304 may further include a broad range of peripheral interfaces for input/output (I/O) 325, such as to enable communication with peripherals, audio codecs, power management, and/or other devices. The SoC(s) 304 may be used to process data from cameras (e.g., connected over Gigabit Multimedia Serial Link and/or Ethernet), sensors (e.g., LiDAR sensor(s) 364, RADAR sensor(s) 360, etc. that may be connected over Ethernet), data from bus 302 (e.g., speed of machine 300, steering wheel position, etc.), data from GNSS sensor(s) 358 (e.g., connected over Ethernet or CAN bus). The SoC(s) 304 may further include dedicated high-performance mass storage controllers that may include their own DMA engines, and that may be used to free the CPU(s) 306 from routine data management tasks. In some embodiments, the SoC(s) 304 I/O 325 may include a header (e.g., a 40 pin header, or 40 pin expansion header) with support for universal asynchronous receiver/transmitter (UART), serial peripheral interface (SPI), inter-integrated circuit sound (I²S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 325 elements, components, or features.

The SoC(s) 304 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 304 may include an RJ45 connector with up to 10 GbE, a 1 GbE connector, and/or other networking connector types.

The SoC(s) 104 may include one or more digital signal processors (DSPs) 343. For example, the DSP(s) 343 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 304 may include one or more video encoders 319 and/or one or more video decoders 321. For example, the video encoder(s) 319 may include a hardware-based (e.g., as part of the GPU(s) 308) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 321 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 321 may be hardware-based (e.g., as part of the GPU(s) 308).

The SoC(s) 304 may include one or more general compute acceleration clusters (GCAC(s)) 329. For example, the GCAC(s) 329 may include various processor types that may be used to accelerate compute, such as one or more vector microcode processors (VMPs) 333, one or more multi-threaded processing clusters (MPCs) 331, one or more programmable macro arrays (PMA(s)) 335, and/or one or more other processor types. For example, the GCAC(s) 329 may include a PMA 335, two VMPs 333, and 2 MPCs 331.

The SoC(s) 304 may include one or more vector microcode processors (VMPs) 333. The VMP(s) 333, in embodiments, may include a wide vector (very long instruction word (VLIW) and single instruction multiple data (SIMD)) machine with performing various operations, such as short integral type operations common in computer vision and deep learning algorithms.

The SoC(s) 304 may include one or more multi-threaded processing clusters (MPCs) 331. The MPC(s) 331 may include a processing cluster that be, in embodiments, more versatile than a GPU, and with higher efficiency than a CPU. For example, the MPC(s) 331 may include a multi-threaded processor that allows multiple threads to share resources and execute instructions concurrently.

The SoC(s) 304 may include one or more programmable macro arrays (PMA(s)) 335. The PMA(s) 335 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 304 may include one or more display processing units (DPUs) 345 for performing hardware-accelerated image processing. For example, the DPU(s) 345 may retrieve pixel data from memory 315 and send it to a display peripheral through standard interfaces. As such, the DPU(s) 345 may handle display processing and rendering for in-machine and/or on-machine displays.

The SoC(s) 304 may include one or more application processing units (APUs) 339. For example, the APU(s) 339 may include a quad or dual-core processor with 48 KB/32 KB L1 cache with parity and ECC, along with a 1 MB L2 cache with ECC. The APU(s) 339 may support NEON instructions and single and double precision floating point operations.

The SoC(s) 304 may include one or more real-time processing units (RTPUs) 369. The RTPU(s) 369 may include a dual-core processor with 32 KB/32 KB L1 cache, and 256 KB TCM with ECC. The RTPU(s) 369 may support single and double precision floating point operations.

The SoC(s) 304 may include one or more built-in self-test (BIST) components 337. For example, the BIST component(s) 337 may include memory BIST (MBIST) to test memories of the system and/or logic BIST (LBIST) to test logic of the system. The BIST components 337 may include embedded logic for directly testing logic and/or memory of the system.

The SoC(s) 304 may include one or more dynamically reconfigurable processors (DRPs) 371. For example, the DRP(s) 371 may be used for accelerating various computing operations. For example, the DRP(s) 371 may be combined, in embodiments, with a MAC unit for use as an AI accelerator. In embodiments, the DRP(s) 371 may execute applications while dynamically switching the circuit connection configuration of the arithmetic units (e.g., ALUs) on the chip at each operating clock according to the content to be processed. Since only the necessary arithmetic circuits are used, the DRP(s) 371 may consume less power than with CPU processing and can achieve higher speed. Furthermore, compared to CPUs, where frequent external memory accesses due to cache misses and other causes will degrade performance, the DRP(s) 371 can build the necessary data paths in hardware ahead of time, resulting in less performance degradation and less variation in operating speed (jitter) due to memory accesses. The DRP(s) 371 may include a dynamic loading function that switches the circuit connection information each time the algorithm changes, enabling processing with limited hardware resources, even in robotic/automotive applications that require processing of multiple algorithms.

In some embodiments, the accelerator(s) 314 may include an OpenCV accelerator for speeding up processing of OpenCV, an open-source industry standard library for computer vision processing. In some embodiments, the combination of one or more DRP(s) 371 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 304 may include various compute engines (e.g., processors 310, CPUs 306, GPU(s) 308, accelerator(s) 314, etc.), tasks may be distributed between and among the compute engines, in some instances without common cause failures due to the discrete footprint of the compute engines. Further, because the SoC(s) 304 may include a dedicated safety processor(s) 313 (or safety island 313), critical safety or redundant operations may be performed without common cause failures from the main processing components or compute engines of the SoC(s) 314. Due to these features, the SoC(s) 304 and/or the underlying systems of the machine 300 may be capable of satisfying higher levels of safety—such as automotive safety integrity level (ASIL) D from the ISO 26262 standard.

FIG. 3E is a system diagram for communication between a cloud-based server(s) (e.g., in a data center, such as those described herein) and the example autonomous or semi-autonomous vehicle or machine 300 of FIG. 3A, in accordance with some embodiments of the present disclosure. The system 376 may include a server(s) 378, a network(s) 390, and a machine(s) 300. The server(s) 378 may include a plurality of GPUs 384(A)-384(H) (collectively referred to herein as GPUs 384), switches 382(A)-382(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 380(A)-380(B) (collectively referred to herein as CPUs 380), accelerators, and/or other processor types. The GPUs 384, the CPUs 380, and the PCIe switches may be interconnected with high-speed interconnects such as, for example and without limitation, NVLink interfaces 388 developed by NVIDIA and/or PCIe connections 386. In some examples, the GPUs 384 are connected via NVLink and/or NVSwitch SoC and the GPUs 384 and the PCIe switches 382 are connected via PCIe interconnects. Although eight GPUs 384, two CPUs 380, and two PCIe switches are illustrated, this is not intended to be limiting. Depending on the embodiment, each of the server(s) 378 may include any number of GPUs 384, CPUs 380, and/or PCIe switches. For example, the server(s) 378 may each include eight, sixteen, thirty-two, and/or more GPUs 384.

The server(s) 378 may receive, over the network(s) 390 and from the machine(s) 300, sensor data indicating information about new or previously unexplored locations, and/or sensor data indicating changes to previously seen/stored locations (e.g., unexpected or changed road conditions, such as recently commenced road-work). The server(s) 378 may transmit, over the network(s) 390 and to the machine(s) 300, neural networks 392, updated neural networks 392, map information 394, etc., including information regarding traffic and road conditions. The updates to the map information 394 may include updates for the HD map 322, SD map, navigation map, etc., such as information regarding construction sites, potholes, detours, flooding, and/or other obstructions. In some examples, the neural networks 392, the updated neural networks 392, the map information 394, and/or the other information may have resulted from new training and/or experiences represented in data received from any number of machine(s) 300 in the environment, and/or based on training performed at a datacenter (e.g., using the server(s) 378 and/or other servers).

The server(s) 378 may be used to train machine learning models (e.g., neural networks) based on training data. The training data may be generated by the machine(s) 300, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 300 (e.g., transmitted to the machine(s) 300 over the network(s) 390, and/or the machine learning models may be used by the server(s) 378 to remotely monitor and/or control the machine(s) 300.

In some examples, the server(s) 378 may receive data from the machine(s) 300 and apply the data to up-to-date real-time neural networks for real-time intelligent inferencing. The server(s) 378 may include deep-learning supercomputers and/or dedicated AI computers powered by GPU(s) 384, such as a DGX and DGX Station machines developed by NVIDIA. However, in some examples, the server(s) 378 may include deep learning infrastructure that use only CPU-powered datacenters.

The deep-learning infrastructure of the server(s) 378 may be capable of fast, real-time inferencing, and may use that capability to evaluate and verify the health of the processors, software, and/or associated hardware in the machine 300. For example, the deep-learning infrastructure may receive periodic updates from the machine 300, such as a sequence of images and/or objects that the machine 300 has located in that sequence of images (e.g., via computer vision and/or other machine learning object classification techniques). The deep-learning infrastructure may run its own neural network to identify the objects and compare them with the objects identified by the machine 300 and, if the results do not match and the infrastructure concludes that the AI in the machine 300 is malfunctioning, the server(s) 378 may transmit a signal to the machine 300 instructing a fail-safe computer of the machine 300 to assume control, notify the passengers, and complete a safety maneuver or operation—such as to slow down, hand control back to a driver, come to a stop, and/or pull over/shut down.

For inferencing, the server(s) 378 may include the GPU(s) 384 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 4 is a system diagram illustrating a three computer ecosystem 400, including a first computing system 402 for generating or creating artificial intelligence (AI)—such as AI training and validation data, a second computing system 404 for training artificial intelligence, and a third computing system 406 (which may include or correspond to the SoC(s) 304 of FIGS. 3A-3E) deploying the AI at the edge, in accordance with at least some embodiments of the present disclosure. For example, to develop and deploy embodied or physical AI, the three computer ecosystem 400 may be used, including three accelerated computer systems to handle physical AI training, simulation, and runtime (e.g., edge deployment). These systems may generate training data for and train multimodal foundation models (and/or other model types) using scalable, physically based simulations of the machine(s) 300 and their worlds. By doing so, simulation of machine(s) 300 may be performed at scale, allowing for refinement, testing, and optimization of skills (e.g., robot skills) in a virtual world (e.g., using NVIDIA's OMNIVERSE) that mimics the laws of physics—helping to reduce real-world data acquisition costs and ensuring the machine(s) 300 can perform safely in controlled settings.

The computing system 404 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 300 to understand natural language and emulate movements by observing human actions. The computing system 404 may include a platform that incorporates software, infrastructure, and expertise in a modern, unified AI development and training solution. The computing system 404 may include individual computing devices 410 (e.g., NVIDIA's DGX B200, H200, etc.) and/or any number of computing devices 410 in a data center infrastructure 412 (e.g., NVIDIA's DGX SuperPOD).

For example, the individual computing devices 410 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 410 may include memory (e.g., 4 TB memory, and storage (e.g., OS storage of 2×1.9 TB NVMe M.2, and internal storage of 8×3.84 TB NVMe U.2). The computing devices 410 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 410 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 410 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 410 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 410 may include a smart host channel adapter (HCA) (e.g., NVIDIA's ConnectX-7) to provide ultra-low latency, 400 Gb/s throughput for in-network computing acceleration engines.

The data center infrastructure 412 may include any number of the computing devices 410, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 410) to thousands, job scheduling and orchestration to ensure hassle-free execution of every developer's job, AI workflow management and machine learning operations (MLOps) to move more models from prototype to production, and enterprise software to speed developer success.

The computing system 402 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 402 allows developers to use simulation frameworks to simulate and validate robot models, and/or to generate massive amounts of physically-based synthetic data to bootstrap model training. The computing system 402 may support learning frameworks that power robot reinforcement learning and imitation learning, to accelerate robot policy training and refinement. For example, the computing system 402 may be used to generate any number of simulations 408—such as within NVIDIA's OMNIVERSE. The computing system 402 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 402 may host or support a native OpenUSD software platform enabling enterprises to connect 3D pipelines and develop advanced, real-time 3D applications for industrial digitalization. With powerful ray-tracing-accelerated AI and graphics capabilities, the computing system 402 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 402 may include individual computing devices 414 (e.g., NVIDIA's OVX L40S Server) and/or any number of computing devices 414 in a data center infrastructure 416 (e.g., NVIDIA's OVX Systems).

The computing device(s) 414 (which may include a server) may include CPUs (e.g., 2 CPUs with 32 cores each), and GPUs (e.g., 4 or 8 GPUs, each including 48 GB GDDR6 with ECC memory, 864 GB/s memory bandwidth, PCIe Gen4×16: 64 GB/s bidirectional interconnect interface, 18,176 CUDA cores, 142 ray tracing (RT) cores, and 568 tensor cores). The computing devices 414 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs—such as an NVIDIA BlueField-3 DPU), providing up to 400 Gb/s InfiniBand/Ethernet. In some embodiments, the NICs used for the computing device(s) 414 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 414 may include a smart host channel adapter (HCA) (e.g., NVIDIA's ConnectX-7) to provide ultra-low latency, 400 Gb/s throughput for in-network computing acceleration engines. The computing device(s) 414 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4TB NVMe).

Similar to the data center infrastructure 412, the data center infrastructure 416 may allow for any number of computing device(s) 414 to be combined in cluster configuration according to a reference architecture.

The computing system 406 may be used to deploy trained AI models on a runtime computer—such as the SoC(s) 304 described herein. For example, these computing systems 406 may be designed for compact, on-board computing needs, including an ensemble of models for control policy, vision and language models, etc., deployed on a power-efficient on-board edge computing system 406. Details of components, features, and capabilities of the computing system 406 may be described in more detail herein with respect to FIGS. 3A-3E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 5 is a block diagram of an example generative language model system 500 suitable for use in implementing at least some embodiments of the present disclosure. In the example illustrated in FIG. 5, the generative language model system 500 includes a retrieval augmented generation (RAG) component 592, an input processor 505, a tokenizer 510, an embedding component 520, plug-ins/APIs 595, and a generative language model (LM) 530 (which may include an LLM, a VLM, a MMLM, a VLA model, etc.).

At a high level, the input processor 505 may receive an input 501 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLM/VLM/MMLM/etc.). In some embodiments, the input 501 includes plain text in the form of one or more sentences, paragraphs, and/or documents. Additionally or alternatively, the input 501 may include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 may combine text (or may omit text) with image data, audio data, video data, design data, USD data, and/or other types of input data, such as but not limited to those described herein. Taking raw input text as an example, the input processor 505 may prepare raw input text in various ways. For example, the input processor 505 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 may remove stopwords to reduce noise and focus the generative LM 530 on more meaningful content. The input processor 505 may apply text normalization (TN), for example, by converting all characters to lowercase, removing accents, and/or or handling special cases like contractions or abbreviations to ensure consistency (e.g., converting ¼ to one quarter). Similarly, the input processor 505 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 592 (which may include one or more RAG models, and/or may be performed using the generative LM 530 itself) may be used to retrieve additional information to be used as part of the input 501 or prompt. RAG may be used to enhance the input to the LLM/VLM/MMLM/etc. with external knowledge, so that answers to specific questions or queries or requests are more relevant—such as in a case where specific knowledge is required. The RAG component 592 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 501 may be generated using the query or input to the model (e.g., a question, a request, etc.) in addition to data retrieved using the RAG component 592. In some embodiments, the input processor 505 may analyze the input 501 and communicate with the RAG component 592 (or the RAG component 592 may be part of the input processor 505, in embodiments) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 may retrieve a prior stored conversation history—or at least a summary thereof—and include the prior conversation history along with the current ask/request as part of the input 501 to the generative LM 530.

The RAG component 592 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 592 and the embeddings of the chunks along with the embeddings of the query may be compared to identify the most similar/related embeddings to the query, which may be supplied to the generative LM 530 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 592 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 510 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy may depend on factors such as the language being processed, the task at hand, and/or characteristics of the training dataset. As such, the tokenizer 510 may convert the (e.g., processed) text into a structured format according to tokenization schema being implemented in the particular embodiment.

The embedding component 520 may use any known embedding technique to transform discrete tokens into (e.g., dense, continuous vector) representations of semantic meaning. For example, the embedding component 520 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 501 may resize the data to a standard size compatible with format of a corresponding input channel and/or may normalize pixel values to a common range (e.g., 0 to 1) to ensure a consistent representation, and the embedding component 520 may encode the image data using any known technique (e.g., using one or more convolutional neural networks (CNNs) to extract visual features). In some implementations in which the input 501 includes audio data, the input processor 501 may resample an audio file to a consistent sampling rate for uniform processing, and the embedding component 520 may use any known technique to extract and encode audio features—such as in the form of a spectrogram (e.g., a mel-spectrogram). In some implementations in which the input 501 includes video data, the input processor 501 may extract frames or apply resizing to extracted frames, and the embedding component 520 may extract features such as optical flow embeddings or video embeddings and/or may encode temporal information or sequences of frames. In some implementations in which the input 501 includes multi-modal data, the embedding component 520 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 520 may apply an encoded representation of the input 501 to the generative LM 530, and the generative LM 530 may process the encoded representation of the input 501 to generate an output 590, which may include responsive text and/or other types of data.

As described herein, in some embodiments, the generative LM 530 may be configured to access or use—or capable of accessing or using—plug-ins/APIs 595 (which may include one or more plug-ins, application programming interfaces (APIs), databases, data stores, repositories, etc.). For example, for certain tasks or operations that the generative LM 530 is not ideally suited for, the model may have instructions (e.g., as a result of training, and/or based on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 595 to the plug-in/API 595, the plug-in/API 595 may process the information and return an answer to the generative LM 530, and the generative LM 530 may use the response to generate the output 590. This process may be repeated—e.g., recursively—for any number of iterations and using any number of plug-ins/APIs 595 until an output 590 that addresses each ask/question/request/process/operation/etc. from the input 501 can be generated. As such, the model(s) may not only rely on its own knowledge from training on a large dataset(s) and/or from data retrieved using the RAG component 592, but also on the expertise or optimized nature of one or more external resources—such as the plug-ins/APIs 595.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s), speaker(s), etc.), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Example 1. A method comprising:
receiving a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determining one or more health statuses respectively corresponding to one or more of the individual processes of the plurality of processes based at least on a comparison between the combined response and the challenge number.

The method of Example 1, wherein the combined response is defined based at least on concatenation of the individual responses of the plurality of responses.

The method of Example 1, wherein the individual responses of the plurality of responses are determined independently.

The method of Example 1, wherein the individual processes represent processes operating at different safety integrity levels.

The method of Example 1, wherein the heartbeat signals are received within a predetermined temporal window.

The method of Example 1, wherein the determining the one or more health statuses comprises identifying an individual process associated with a mismatched response with respect to the challenge number.

The method of Example 1, wherein the determining the one or more health statuses comprises applying a set of functions to portions of the challenge number to generate an expected response and comparing the expected response to the combined response.

The method of Example 1, wherein the set of functions comprises a plurality of unique and independent functions, each function corresponding to an individual process of the plurality of processes.

The method of Example 1, wherein the one or more heartbeat signals represents statuses of one or more child processes associated with the individual processes.

Example 2. A system comprising:
one or more processors to:
receive a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determine one or more health statuses respectively corresponding to one or more of the individual processes of the plurality of processes based at least on a comparison between the combined response and the challenge number.

The system of Example 2, wherein the combined response is defined based at least on concatenation of the individual responses of the plurality of responses.

The system of Example 2, wherein the individual responses of the plurality of responses are determined independently.

The system of Example 2, wherein the individual processes represent processes operating at different safety integrity levels.

The system of Example 2, wherein the heartbeat signals are received within a predetermined temporal window.

The system of Example 2, wherein the determining the one or more health statuses comprises identifying an individual process associated with a mismatched response with respect to the challenge number.

The system of Example 2, wherein the determining the one or more health statuses comprises applying a set of functions to portions of the challenge number to generate an expected response and comparing the expected response to the combined response.

The system of Example 2, wherein the set of functions comprises a plurality of unique and independent functions, each function corresponding to an individual process of the plurality of processes.

The system of Example 2, wherein the one or more heartbeat signals represents statuses of one or more child processes associated with the individual processes.

The system of Example 2, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

Example 3. One or more processors comprising:
processing circuitry to perform operations comprising:
receive a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determine one or more health statuses respectively corresponding to one or more of the individual processes of the plurality of processes based at least on a comparison between the combined response and the challenge number.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including handheld devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising:
receiving a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determining one or more health statuses respectively corresponding to one or more of the individual processes of the plurality of processes based at least on a comparison between the combined response and the challenge number.

2. The method of claim 1, wherein the combined response is defined based at least on concatenation of the individual responses of the plurality of responses.

3. The method of claim 1, wherein the individual responses of the plurality of responses are determined independently.

4. The method of claim 1, wherein the individual processes represent processes operating at different safety integrity levels.

5. The method of claim 1, wherein the heartbeat signals are received within a predetermined temporal window.

6. The method of claim 1, wherein the determining the one or more health statuses comprises identifying an individual process associated with a mismatched response with respect to the challenge number.

7. The method of claim 1, wherein the determining the one or more health statuses comprises applying a set of functions to portions of the challenge number to generate an expected response and comparing the expected response to the combined response.

8. The method of claim 7, wherein the set of functions comprises a plurality of unique and independent functions, each function corresponding to an individual process of the plurality of processes.

9. The method of claim 1, wherein the one or more heartbeat signals represents statuses of one or more child processes associated with the individual processes.

10. A system comprising:
one or more processors to:
receive a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determine one or more health statuses respectively corresponding to one or more of the individual processes of the plurality of processes based at least on a comparison between the combined response and the challenge number.

11. The system of claim 10, wherein the combined response is defined based at least on concatenation of the individual responses of the plurality of responses.

12. The system of claim 10, wherein the individual responses of the plurality of responses are determined independently.

13. The system of claim 10, wherein the individual processes represent processes operating at different safety integrity levels.

14. The system of claim 10, wherein the heartbeat signals are received within a predetermined temporal window.

15. The system of claim 10, wherein the determining the one or more health statuses comprises identifying an individual process associated with a mismatched response with respect to the challenge number.

16. The system of claim 10, wherein the determining the one or more health statuses comprises applying a set of functions to portions of the challenge number to generate an expected response and comparing the expected response to the combined response.

17. The system of claim 16, wherein the set of functions comprises a plurality of unique and independent functions, each function corresponding to an individual process of the plurality of processes.

18. The system of claim 10, wherein the one or more heartbeat signals represents statuses of one or more child processes associated with the individual processes.

19. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

20. One or more processors comprising processing circuitry to:
receive a combined response corresponding to a challenge number, the combined response including a plurality of responses respectively corresponding to a plurality of processes, individual responses of the plurality of responses generated based at least on reception of one or more heartbeat signals corresponding to individual processes of the plurality of processes; and
determine one or more health statuses respectively corresponding to one or more of the individual processes of the plurality of processes based at least on a comparison between the combined response and the challenge number.
